(19) United States
(12) Patent Application Publication
(10) Pub. No.: US 2024/0389079 A1
(43) Pub. Date: Nov. 21, 2024

(54) COMMUNICATION METHOD AND APPARATUS, COMPUTER-READABLE STORAGE MEDIUM, COMPUTER PROGRAM PRODUCT, AND CHIP

(71) Applicant: HUAWEI TECHNOLOGIES CO., LTD., Shenzhen (CN)

(72) Inventors: Ting WANG, Shanghai (CN); Yongxia LYU, Shenzhen (CN); Dongdong WEI, Shanghai (CN)

(73) Assignee: HUAWEI TECHNOLOGIES CO., LTD., Shenzhen (CN)

(21) Appl. No.: 18/758,531

(22) Filed: Jun. 28, 2024

Related U.S. Application Data
(63) Continuation of application No. PCT/CN2022/141955, filed on Dec. 26, 2022.

(30) Foreign Application Priority Data
Dec. 31, 2021 (CN) 202111673247.6

(51) Int. Cl. H04W 72/044; H04L 5/00

(52) U.S. Cl. CPC H04W 72/044; H04L 5/005

(57) ABSTRACT

In a communication method, a first communication apparatus obtains first configuration information of a first signal, where the first configuration information is associated with a first communication procedure of the first communication apparatus. The first communication apparatus obtains second configuration information of the first signal, where the second configuration information is associated with a second communication procedure of the first communication apparatus. The first communication apparatus sends the first signal based on at least one of the first configuration information or the second configuration information. In this way, the first communication apparatus can use a same type of signals to perform different communication procedures. This reduces processing complexity, and can further reduce chip costs of the first communication apparatus and improve resource utilization.

### CROSS-REFERENCE TO RELATED APPLICATIONS

This application is a continuation of International Application No. PCT/CN2022/141955, filed on Dec. 26, 2022, which claims priority to Chinese Patent Application No. 202111673247.6, filed on Dec. 31, 2021. The disclosures of the aforementioned applications are hereby incorporated by reference in their entireties.

### TECHNICAL FIELD

This disclosure relates to the communication field, and more specifically, to a communication method and apparatus, a computer-readable storage medium, a computer program product, and a chip.

### BACKGROUND

A terminal device may send a preamble sequence on a physical random access channel (PRACH) to initiate an initial access process. New radio (NR) defines four long preamble sequence formats and nine short preamble sequence formats, which are applicable to different scenarios. Different preamble sequence formats correspond to different cycle prefix (CP) lengths and different sequence lengths. Designs of the plurality of preamble sequence formats are relatively complex, and the need to reserve PRACH resources for transmission of preamble sequences leads to a waste of resources. Consequently, communication efficiency is low. In addition, after completing initial access, the terminal device may send a sounding reference signal (SRS). The sounding reference signal is used by a network device to obtain an uplink channel status used for uplink synchronization. Therefore, the terminal device needs to send a PRACH and an SRS. As a result, processing complexity at the terminal device is relatively high, chip costs are relatively high, and large-scale commercial use cannot be implemented.

### SUMMARY

Embodiments of this disclosure provide a communication method and apparatus, a computer-readable storage medium, a computer program product, and a chip.

According to a first aspect of embodiments of this disclosure, a communication method is provided. The method includes: a first communication apparatus obtains first configuration information of a first signal, where the first configuration information is associated with a first communication procedure of the first communication apparatus; the first communication apparatus obtains second configuration information of the first signal, where the second configuration information is associated with a second communication procedure of the first communication apparatus; and the first communication apparatus sends the first signal based on at least one of the first configuration information or the second configuration information. In this way, the first communication apparatus can use a same type of signals for different communication procedures. This reduces processing complexity, and can further reduce chip costs of the first communication apparatus. In addition, a same signal can be used for different communication procedures so that resource utilization can be improved.

In some implementations, that the first communication apparatus obtains first configuration information of a first signal includes: the first communication apparatus receives the first configuration information from the second communication apparatus. Therefore, the second communication apparatus can configure different first configuration information for different first communication apparatuses.

In some implementations, that the first communication apparatus obtains first configuration information of a first signal includes: the first communication apparatus receives a plurality of first configuration information sets of the first signal, and obtains the first configuration information from the plurality of first configuration information sets. When the first configuration information is obtained in this manner, signaling overheads can be reduced.

In some implementations, that the first communication apparatus obtains first configuration information of a first signal includes: the first communication apparatus obtains the first configuration information based on at least one of the following: a capability of the first communication apparatus, a position of the first communication apparatus, a moving speed of the first communication apparatus, or a type of the first communication apparatus. The first configuration information of the first signal is obtained in this manner so that signaling overheads can be reduced. In addition, different first configuration information may be configured for different terminal devices, different capabilities, positions, moving speeds, types, and the like of a terminal device, to meet requirements of different users and to improve communication efficiency and performance.

In some implementations, that the first communication apparatus obtains first configuration information of a first signal includes at least one of the following: the first communication apparatus obtains a plurality of first configuration information sets of the first signal, or obtains the first configuration information from the plurality of first configuration information sets. The first configuration information of the first signal is obtained in this manner so that signaling overheads can be reduced.

In some implementations, that the first communication apparatus obtains a plurality of first configuration information sets of the first signal may be obtaining the plurality of first configuration information sets of the first signal from the second communication apparatus, or may be obtaining the plurality of first configuration information sets of the first signal from a third communication apparatus; or the plurality of first configuration information sets may be predefined in a protocol. The first configuration information of the first signal is obtained in this manner so that signaling overheads can be reduced.

In some implementations, obtaining the first configuration information based on the type of the first communication apparatus includes: obtaining a plurality of first configuration information sets of the first signal; and obtaining the first configuration information from the plurality of first configuration information sets based on the first communication procedure and the type of the first communication apparatus. The first configuration information of the first signal is obtained in this manner so that signaling overheads can be reduced. In addition, different first configuration information may be configured for different types of terminal devices, different communication procedures, and the like, to meet requirements of different users and to improve communication efficiency and performance.

In some implementations, that the first communication apparatus obtains second configuration information of the first signal includes at least one of the following: the first communication apparatus receives the second configuration information from the second communication apparatus; or the first communication apparatus receives a plurality of second configuration information sets of the first signal and obtains the second configuration information from the plurality of first configuration information sets. The second configuration information of the first signal is obtained in this manner so that signaling overheads can be reduced.

In some implementations, the first communication apparatus obtains the second configuration information based on at least one of the following: the capability of the first communication apparatus, the position of the first communication apparatus, the moving speed of the first communication apparatus, or the type of the first communication apparatus. The second configuration information of the first signal is obtained in this manner so that signaling overheads can be reduced. In addition, different second configuration information may be configured for different terminal devices, different capabilities, positions, moving speeds, types, and the like of a terminal device, to meet requirements of different users and to improve communication efficiency and performance.

In some implementations, that the first communication apparatus obtains second configuration information of the first signal includes at least one of the following: the first communication apparatus obtains a plurality of second configuration information sets of the first signal or obtains the second configuration information from the plurality of second configuration information sets. The second configuration information of the first signal is obtained in this manner so that signaling overheads can be reduced.

In some implementations, the first communication apparatus obtains the second configuration information based on at least one of the following: the capability of the first communication apparatus, the position of the first communication apparatus, the moving speed of the first communication apparatus, or the type of the first communication apparatus. The second configuration information of the first signal is obtained in this manner so that signaling overheads can be reduced. In addition, different second configuration information may be configured for different types of terminal devices, different communication procedures, and the like, to meet requirements of different users and to improve communication efficiency and performance.

In some implementations, that the first communication apparatus obtains a plurality of second configuration information sets of the first signal may be obtaining the plurality of second configuration information sets of the first signal from the second communication apparatus, or may be obtaining the plurality of second configuration information sets of the first signal from the third communication apparatus; or the plurality of second configuration information sets may be predefined in a protocol. The second configuration information of the first signal is obtained in this manner so that signaling overheads can be reduced.

In some implementations, obtaining the second configuration information based on the type of the first communication apparatus includes: obtaining a plurality of second configuration information sets of the first signal; and obtaining the second configuration information from the plurality of second configuration information sets based on the second communication procedure and the type of the first communication apparatus. The second configuration information of the first signal is obtained in this manner so that signaling overheads can be reduced. In addition, different second configuration information may be configured for different types of terminal devices, different communication procedures, and the like, to meet requirements of different users and to improve communication efficiency and performance.

In some implementations, the first configuration information is associated with a first identifier of a synchronization signal block; and/or the second configuration information is associated with a second identifier of the synchronization signal block. The configuration information of the first signal is obtained in this manner so that signaling overheads can be reduced.

In some implementations, the first configuration information is associated with a first resource identifier of a channel state information reference signal; and/or the second configuration information is associated with a second resource identifier of the channel state information reference signal. The configuration information of the first signal is obtained in this manner so that signaling overheads can be reduced.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus. In this way, the first communication apparatus can use a same type of signals to perform initial access and perform channel sounding, beam selection, or beam recovery. This reduces processing complexity, and can further reduce chip costs of the first communication apparatus. In addition, a same signal can be used for different communication procedures so that resource utilization can be improved.

In some implementations, the first signal includes one of the following: a sounding reference signal; and a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence. The first configuration information and/or the second configuration information of the first signal are/is obtained in this manner so that flexible configuration of the foregoing parameters can be implemented. In addition, different parameter values may be configured for different types of terminal devices, different communication procedures, and the like, to meet requirements of different users and to improve communication efficiency and performance.

According to a second aspect of embodiments of this disclosure, a communication method is provided. The method includes: A second communication apparatus determines first configuration information of a first signal, where the first configuration information is associated with a first communication procedure of a first communication apparatus; the second communication apparatus determines second configuration information of the first signal, where the second configuration information is associated with a second communication procedure of the first communication apparatus; and the second communication apparatus receives the first signal from the first communication apparatus based on at least one of the first configuration information or the second configuration information.

In some implementations, the method further includes: sending the first configuration information and/or a plurality of first configuration information sets of the first signal to the first communication apparatus.

In some implementations, the method further includes: sending the second configuration information and/or a plurality of second configuration information sets of the first signal to the first communication apparatus.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus.

In some implementations, the first signal includes one of the following: a sounding reference signal; and a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

According to a third aspect of embodiments of this disclosure, a first communication apparatus is provided. The first communication apparatus may include a corresponding module or unit for performing each of the method/operations/steps/actions described in the first aspect. The module or unit may be a hardware circuit, or may be software, or may be implemented by a hardware circuit in combination with software. In a possible implementation, the first communication apparatus includes: a first obtaining unit, configured to obtain first configuration information of a first signal, where the first configuration information is associated with a first communication procedure of the first communication apparatus; a second obtaining unit, configured to obtain second configuration information of the first signal, where the second configuration information is associated with a second communication procedure of the first communication apparatus; and a sending unit, configured to send the first signal based on at least one of the first configuration information or the second configuration information.

In some implementations, the first obtaining unit and the second obtaining unit each may be a processing unit.

In some implementations, the first communication apparatus further includes a receiving unit. The receiving unit is configured to receive the first configuration information from a second communication apparatus. The first obtaining unit is configured to obtain the first configuration information.

In some implementations, the first communication apparatus further includes a receiving unit. The receiving unit receives a plurality of first configuration information sets of the first signal. The first obtaining unit is further configured to obtain the first configuration information from the plurality of first configuration information sets.

In some implementations, the first obtaining unit is further configured to obtain the first configuration information based on at least one of the following: a capability of the first communication apparatus, a position of the first communication apparatus, a moving speed of the first communication apparatus, or a type of the first communication apparatus.

In some implementations, the first obtaining unit is configured to: obtain a plurality of first configuration information sets of the first signal; and obtain the first configuration information from the plurality of first configuration information sets based on the first communication procedure and the type of the first communication apparatus.

In some implementations, the second obtaining unit is configured to: receive the second configuration information from the second communication apparatus; receive a plurality of second configuration information sets of the first signal, and obtain the second configuration information from the plurality of first configuration information sets; or obtain the second configuration information based on at least one of the following: the capability of the first communication apparatus, the position of the first communication apparatus, the moving speed of the first communication apparatus, or the type of the first communication apparatus.

In some implementations, obtaining the second configuration information based on the type of the first communication apparatus includes: obtaining a plurality of second configuration information sets of the first signal; and obtaining the second configuration information from the plurality of second configuration information sets based on the second communication procedure and the type of the first communication apparatus.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

According to a fourth aspect of embodiments of this disclosure, a second communication apparatus is provided. The second communication apparatus may include a corresponding module or unit for performing each of the method/operations/steps/actions described in the second aspect. The module or unit may be a hardware circuit, or may be software, or may be implemented by a hardware circuit in combination with software. In a possible implementation, the second communication apparatus includes: a first determining unit, configured to determine first configuration information of a first signal, where the first configuration information is associated with a first communication procedure of a first communication apparatus; a second determining unit, configured to determine second configuration information of the first signal, where the second configuration information is associated with a second communication procedure of the first communication apparatus; and a receiving unit, configured to receive the first signal from the first communication apparatus based on at least one of the first configuration information or the second configuration information.

In some implementations, the first determining unit and the second determining unit each may be a processing unit.

In some implementations, the first configuration information is associated with a first identifier of a synchronization signal block; and/or the second configuration information is associated with a second identifier of the synchronization signal block.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus.

In some implementations, the first signal includes one of the following: a sounding reference signal; and a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

According to a fifth aspect of implementations of this disclosure, a first communication apparatus is provided. The first communication apparatus includes a processor, configured to execute a computer program (or computer-executable instructions) stored in a memory. When the computer program (or the computer-executable instructions) is executed, the apparatus is enabled to perform the method according to the first aspect and the possible implementations of the first aspect.

In a possible implementation, the processor is integrated with the memory.

In another possible implementation, the memory is located outside the first communication apparatus.

Optionally, the first communication apparatus further includes a communication interface. The communication interface is for communication between the first communication apparatus and another device, for example, sending or receiving of data and/or a signal. For example, the communication interface may be a transceiver, a circuit, a bus, a module, or another type of communication interface.

According to a sixth aspect of implementations of this disclosure, a second communication apparatus is provided. The second communication apparatus includes a processor, configured to execute a computer program (or computer-executable instructions) stored in a memory. When the computer program (or the computer-executable instructions) is executed, the apparatus is enabled to perform the method according to the second aspect and the possible implementations of the second aspect.

In a possible implementation, the processor is integrated with the memory.

In another possible implementation, the memory is located outside the second communication apparatus.

Optionally, the second communication apparatus further includes a communication interface. The communication interface is for communication between the second communication apparatus and another device, for example, sending or receiving of data and/or a signal. For example, the communication interface may be a transceiver, a circuit, a bus, a module, or another type of communication interface.

According to a seventh aspect of implementations of this disclosure, a computer-readable storage medium is provided. The computer-readable storage medium stores a computer program. When the computer program is executed by a processor, an operation of the method according to any one of the possible implementations of the first aspect and/or the second aspect is implemented.

According to an eighth aspect of implementations of this disclosure, a computer program product is provided. The computer program product is tangibly stored in a computer-readable medium and includes computer-executable instructions. When the computer-executable instructions are executed, a device is enabled to implement an operation of the method according to any one of the possible implementations of the first aspect and/or the second aspect.

According to a ninth aspect of implementations of this disclosure, a chip is provided. The chip is configured to perform an operation of the method according to any one of the possible implementations of the first aspect and/or the second aspect.

It may be understood that the foregoing provided communication apparatuses, medium, computer program product, or chip is configured to implement the method provided in the first aspect and/or the second aspect. Therefore, the explanations or descriptions of the first aspect and/or the second aspect are also applicable to the communication apparatuses, the medium, the computer program product, or the chip provided in the foregoing aspects. In addition, for beneficial effects that can be achieved by the communication apparatuses, the medium, the computer program product, or the chip provided in these aspects, refer to beneficial effects in corresponding methods. Details are not described herein again.

These aspects and other aspects of this disclosure are more concise and easier to understand in descriptions of the following (a plurality of) implementations.

### BRIEF DESCRIPTION OF DRAWINGS

Features, advantages, and other aspects of the implementations of this disclosure become clearer with reference to the accompanying drawings and the following detailed descriptions. Several implementations of this disclosure are shown herein by way of example rather than limitation. In the accompanying drawings:

FIG. 1 is a schematic block diagram of a communication system to which embodiments of this disclosure are applicable;

FIG. 2 is a signaling interaction diagram of a communication process according to some embodiments of this disclosure;

FIG. 3A and FIG. 3B each are a diagram of resource blocks used to transmit a first signal according to some embodiments of this disclosure;

FIG. 4A and FIG. 4B each are a diagram of subcarriers used to transmit a first signal according to some embodiments of this disclosure;

FIG. 5 is a signaling interaction diagram of a communication process according to some other embodiments of this disclosure;

FIG. 6A, FIG. 6B and FIG. 6C each show an example of contention-based initial access parameters according to some embodiments of this disclosure;

FIG. 7 is a signaling interaction diagram of a communication process according to still some other embodiments of this disclosure;

FIG. 8A, FIG. 8B, and FIG. 8C each show a transmission scheme of a first signal according to some embodiments of this disclosure;

FIG. 9 is a flowchart of a communication method according to some embodiments of this disclosure;

FIG. 10 is a flowchart of a communication method according to some other embodiments of this disclosure;

FIG. 11 is a signaling interaction diagram of a communication process according to yet some other embodiments of this disclosure;

FIG. 12 is a flowchart of a communication method according to still some other embodiments of this disclosure;

FIG. 13 is a schematic block diagram of a communication apparatus according to some embodiments of this disclosure;

FIG. 14 is a schematic block diagram of a communication apparatus according to some other embodiments of this disclosure;

FIG. 15 is a schematic block diagram of a communication apparatus according to still some other embodiments of this disclosure; and

FIG. 16 is a simplified block diagram of an example device suitable for implementing embodiments of this disclosure.

In the accompanying drawings, same or similar reference numerals represent same or similar elements.

### DESCRIPTION OF EMBODIMENTS

The following describes embodiments of this disclosure in more detail with reference to the accompanying drawings. Although some embodiments of this disclosure are shown in the accompanying drawings, it should be understood that this disclosure may be implemented in various forms and should not be construed to be limited to embodiments described herein. Instead, these embodiments are provided to understand this disclosure more thoroughly and completely. It should be understood that, the accompanying drawings and embodiments of this disclosure are merely used as examples, but are not used to limit the protection scope of this disclosure.

In descriptions of embodiments of this disclosure, the term “including” and similar terms should be understood as non-exclusive inclusion, namely, “including but not limited to”. The term “based on” should be understood as “at least partially based on”. The term “one embodiment” or “this embodiment” should be understood as “at least one embodiment”. The terms “first”, “second”, and the like may refer to different objects or a same object. Other explicit and implied definitions may be included below.

For ease of understanding, the following describes concepts related to this disclosure.

1. Enhanced Mobile Broadband (eMBB)

An eMBB service scenario is a further improvement on an existing mobile broadband service scenario in performance such as a network speed and user experience, and is also an application scenario closest to people's daily life. For example, when a user watches a 4K high-definition video, a peak rate can reach 10 Gbps. For example, an eMBB service may be a large-traffic mobile broadband service such as a three-dimensional (3D) video or an ultra-high-definition video.

### 2. Ultra Reliable Low Latency Communication (URLLC)

URLLC may be a service featuring high reliability, a low latency, and extremely high availability. The URLLC may include the following types of scenarios and disclosures: industrial disclosure and control, traffic safety and control, remote manufacturing, remote training, remote surgery, self driving, security industry, and the like.

### 3. Machine Type Communication (MTC)

MTC may be a service featuring low costs and enhanced coverage, and is also referred to as machine to machine (M2M) communication. mMTC is a massive machine type communication service.

### 4. Internet of Things (IoT) System

IoT may be a service featuring wide coverage, a large quantity of connections, a low rate, low costs, low power consumption, an excellent architecture, and the like, for example, a service featuring massive connections, lower power consumption, and lower chip costs. For example, the IoT system may be an internet of things device, a smart water meter, smart parking system, smart pet tracking system, a smart bicycle, a smart smoke detector, a smart toilet, a smart vending machine, or the like. The IoT system may alternatively be a sensor, a controller, or the like, for example, a temperature sensor, a humidity sensor, a fire alarm, or a detector.

An IoT terminal may include one or more of the following: an MTC terminal, a narrowband IoT (NB-IoT) terminal, an mMTC terminal, and the like.

### 5. Customer Premise Equipment (CPE)

CPE may be a mobile signal access device that receives a mobile signal and forwards the mobile signal in the form of wireless fidelity (Wi-Fi) signal, or may be a device that converts a high-speed 4th generation (4G) signal or a high-speed 5th generation (5G) signal into a Wi-Fi signal. The CPE may support a relatively large quantity of mobile terminals in simultaneously accessing a network. The CPE can be widely used for wireless network access in rural areas, towns, hospitals, companies, factories, residential communities, and the like, to reduce costs of wired network deployment.

### 6. Augmented Reality/Virtual Reality

Augmented reality (AR).

Virtual reality (VR).

### 7. Vehicle to Everything (V2X)

V2X is a key technology for an intelligent transportation system. The V2X enables communication between vehicles, communication between a vehicle and a base station, and between base stations. In this way, a range of traffic information such as a real-time road condition, road information, and pedestrian information can be obtained, to improve driving safety, reduce congestion and to improve traffic efficiency and the like. In addition, in-vehicle entertainment information, and the like can be provided.

### 8. Type of a Terminal

In this disclosure, different types of terminals differ in at least one of the following attributes: supported service types, requirements for mobility, requirements for service data transmission latencies, radio channel environments in which the terminals are located, requirements for service data transmission reliability, requirements for coverage, or deployment scenarios.

Alternatively, a terminal has at least one of the following types: an eMBB terminal, a URLLC terminal, an IoT terminal, CPE, an AR terminal, a VR terminal, an MTC terminal, or a V2X terminal.

Optionally, the type of the terminal may also be a service type of the terminal.

Technical solutions in embodiments of this disclosure may be applied to various communication systems, for example, a long term evolution (LTE) system, an LTE frequency division duplex (FDD) system, an LTE time division duplex (TDD) system, a 5G system or an NR communication system, a satellite communication system, a mobile communication system that is evolved from 5G such as a 6G mobile communication system, and the like. The technical solutions in embodiments of this disclosure may further be applied to an LTE and 5G hybrid networking system, a device-to-device (D2D) communication system, an M2M communication system, an IoT system, a full-duplex system, an access backhaul system, a relay system, or the like. The communication system may be a 3rd generation partnership project (3GPP) communication system, or may be a non-3GPP communication system. This is not limited.

The technical solutions in embodiments of this disclosure may be applied to various scenarios in which signal transmission exists, for example, a scenario in which an access network device communicates with a terminal, a scenario in which an access network device communicates with an access network device, a scenario in which a terminal communicates with a terminal, a scenario in which a terminal communicates with a core network device, an internet of vehicles scenario, an internet of things scenario, and an industrial internet scenario.

In embodiments of this disclosure, a scenario in which a terminal communicates with a network device is used as an example to describe the technical solutions of this disclosure. The network device may be an access network device, or may be a core network device. This is not limited.

In embodiments of this disclosure, the terminal may also be referred to as a terminal device, a user, an access terminal, a subscriber unit, a subscriber station, a mobile station, a mobile console, a remote station, a remote terminal, a mobile device, a user terminal, user equipment (UE), a wireless communication device, a user agent, a user apparatus, or the like. The terminal may be a device that provides voice and/or data connectivity for a user. The terminal may be a cellular phone, a smart watch, a wireless data card, a mobile phone, a tablet computer, a personal digital assistant (PDA) computer, a wireless modem, a handheld device, a laptop computer, an MTC terminal, a computer with a wireless transceiver function, or a handheld device or a vehicle-mounted device with a wireless connection function. Alternatively, the terminal may be a palmtop computer, a mobile internet device (MID), a wearable device, an eMBB terminal, a URLLC terminal, an MTC terminal, an IoT terminal, a CPE terminal, a V2X terminal, an internet of things terminal, a virtual reality terminal, an augmented reality terminal, a wireless terminal in industrial control, a wireless terminal in self driving, a wireless terminal in remote surgery, a wireless terminal in remote medical, a wireless terminal in smart grid, a wireless terminal in transportation safety, a wireless terminal in smart city, a wireless terminal in smart home, a sensor, a cordless phone, a session initiation protocol (SIP) phone, a wireless local loop (WLL) station, a personal digital assistant (PDA), a computing device or another processing device connected to a wireless modem, a wireless terminal (for example, a satellite phone or a satellite terminal) in satellite communication, or the like. The terminal may be an unmanned aerial vehicle (UAV) with a capability of unmanned aerial vehicle-to-unmanned aerial vehicle communication, a terminal device in a 5G network, a terminal device in a future network, a terminal device in a future evolved public land mobile network PLMN), or the like. This is not limited. The terminal can send a signal and/or receive a signal. The network device can send a signal to the terminal and/or receive a signal sent by the terminal. The terminal can complete direct interaction with the network device over an air interface. A specific technology and a specific device form used by the terminal are not limited in embodiments of this disclosure.

The wearable device may also be referred to as a wearable intelligent device, and is a general term of wearable devices, such as glasses, gloves, watches, clothes, and shoes, that are intelligently designed and developed for daily wear by applying wearable technologies. The wearable device is a portable device that is directly worn on a body or integrated into a user's clothes or accessories. The wearable device is a hardware device, and implements a powerful function through software support, data exchange, and cloud interaction. In a broad sense, wearable intelligent devices include full-featured and large-sized devices that can implement complete or partial functions without depending on a smartphone, for example, smart watches or smart glasses, and devices that focus on only one type of application functions and need to be used together with another device such as a smartphone, for example, various smart bands and smart jewelry.

In addition, the terminal may alternatively be a terminal device in an internet of things system. IoT is an important part in future development of information technologies. A main technical feature of the IoT is to connect things to a network by using a communication technology, to implement an intelligent network for human-machine interconnection and thing-thing interconnection. The IoT technology can achieve massive connections, deep coverage, and terminal power saving by using, for example, a narrowband (NB) technology.

In addition, the terminal may alternatively include sensors such as an intelligent printer, a train detector, and a gas station, and main functions include: collecting data, receiving control information and data of the network device, sending an electromagnetic wave, and transmitting data to the network device.

In embodiments of this disclosure, the access network device may be any device with a wireless transceiver function. The access network device may be an access device through which the terminal accesses a mobile communication system in a wireless manner, and may be configured to be responsible for functions related to an air interface (for example, a radio link maintenance function, maintaining a radio link with a terminal, and being responsible for protocol conversion between radio link data and IP data; radio resource management functions, including radio link establishment and release, radio resource scheduling and allocation, and the like; and some mobility management functions, including configuring a terminal for measurement, evaluating radio link quality of a terminal, making a decision on handover of a terminal between cells, and the like), and functions such as quality of service management, and data compression and encryption. The access network device may be an evolved NodeB (eNB or eNodeB) in an LTE system, a transmission reception point (TRP), a macro base station, a micro base station, a microcell, a small cell, a small base station (micro gNB/NodeB or pico gNB/NodeB), a radio controller in a cloud radio access network (CRAN) scenario, an access point in a wireless fidelity system, a relay station, a vehicle-mounted device, a wearable device, or the like. Alternatively, the access network device may be a terminal that undertakes a base station function in D2D communication or machine communication. Alternatively, the access network device may be a base station in a 5G network, a base station in a 6G network, a base station in a future evolved PLMN network, or the like.

For example, the access network device may also be referred to as a network device. The access network device may be a device supporting wired access, or may be a device supporting wireless access. For example, the access network device may be an access network (AN) device or a radio access network (RAN) device, and includes a plurality of AN nodes or a plurality of RAN nodes. The AN node or the RAN node may be an access point (AP), an NB, an eNB, a next generation NodeB (gNB), a TRP, a transmission point (t TP), or another access node.

For example, the access network device may be a gNB, a TRP, an eNB, an RNC, a home base station (for example, a home evolved NodeB or a home NodeB, HNB), a wireless fidelity (Wi-Fi) access point (AP), a wireless relay node, a wireless backhaul node, a transmission point (TP), or a transmission reception point (TRP). Alternatively, the access network device may be a device undertakes a base station function in 5G communication, for example, an gNB or a transmission point (TRP or TP) in an NR system, an antenna panel or a group of antenna panels of a base station in a 5G system, or a network node that forms a gNB or a transmission point, such as a baseband unit (BBU) or a distributed unit (DU); or may be a device that undertakes a base station function in D2D, V2X, or M2M communication, a base station in a future communication system, or the like.

In addition, the access network device may alternatively be a module or unit that implements some base station functions, for example, a central unit (CU) or a distributed unit (DU). The access network device may further include an active antenna unit (AAU). The CU may implement some functions of the access network device, and the DU may implement some functions of the access network device. For example, the CU is responsible for processing a non-real-time protocol and a non-real-time service, and implements functions of a radio resource control RRC layer and a packet data convergence protocol (PDCP) layer; and the DU is responsible for processing a physical layer protocol and a real-time service, and implements functions of a radio link control (RLC) layer, a medium access control (MAC) layer, and a physical (PHY) layer. The AAU implements some physical layer processing functions, and a function related to radio frequency processing and an active antenna. Information at the RRC layer eventually becomes information at the PHY layer, or is converted from information at the PHY layer. Therefore, in this architecture, higher layer signaling such as RRC layer signaling may also be considered as being sent by the DU or sent by the DU and the AAU. It may be understood that the network device may be a device including one or more of a CU node, a DU node, and an AAU node. In addition, the CU may be classified as a network device in an access network (AN) or a radio access network (RAN), or the CU may be classified as a network device in a core network (CN). This is not limited in this disclosure.

The access network device may send a signal to the terminal and/or receive a signal sent by the terminal. A specific technology and a specific device form used by the access network device are not limited in embodiments of this disclosure.

The access network device may provide a service for a cell, and the terminal communicates with the cell through a transmission resource (for example, a frequency-domain resource or a spectrum resource) allocated by the access network device. The cell may belong to a macro base station (for example, a macro eNB or a macro gNB), or may belong to a base station corresponding to a small cell. The small cell may include a metrocell, a microcell, a picocell, a femtocell, and the like. These small cells feature small coverage and a low transmit power, and are applicable to providing a high-rate data transmission service.

In embodiments of this disclosure, main functions of the core network are to provide a user connection, manage a user, complete service carrying, and act as a bearer network to provide an interface to an external network. Establishment of the user connection includes functions such as mobility management (MM), call management (CM), switching/routing, and completing a connection relationship to an intelligent network peripheral device in combination with an intelligent network service. User management includes user description, quality of service QoS) (description of user service QoS is added), a virtual home environment (VHE) (the virtual home environment is provided through dialogue with an intelligent network platform), and security (security measures provided by an authentication center include security management for mobile services and security processing for external network access). A bearer connection (access to) includes a public switched telephone network (PSTN) connected to the outside, an external circuit data network and a packet data network, the internet and an intranet, a short message service (SMS) server, and the like. Basic services that can be provided by the core network include mobile office, e-commerce, communication, an entertainment service, a travel and location-based service, a telemetry service, namely, a simple message transfer service, and the like. As a core part of a mobile communication network, the core network functions as a link between upper and lower layers. For example, a core network device in embodiments of this disclosure may include a user plane function (UPF) network element, an access and mobility management function (AMF) network element, a session management function SMF) network element, an application function (AF) network element, and the like.

In embodiments of this disclosure, the terminal and the access network device may include a user plane protocol and a control plane protocol. A terminal side and an access network device side may include a physical layer (PHY), a medium access control (MAC) layer, a radio link control (RLC) layer, a packet data convergence protocol (PDCP) layer, a service data adaptation protocol (SDAP) layer, and an RRC layer. The layers of the terminal and the access network device may be connected to each other to transfer information.

Embodiments of this disclosure are applicable to both a homogeneous network scenario and a heterogeneous network scenario, and no limitation is imposed on a transmission point. Coordinated multipoint transmission may be performed between macro base stations, between micro base stations, and between a macro base station and a micro base station.

Application scenarios of the network device and the terminal are not limited in embodiments of this disclosure. For example, the network device and the terminal may be deployed on land, including indoors or outdoors, and handheld or vehicle-mounted, or may be deployed on water, or may be deployed on an airplane, a balloon, and an artificial satellite in the air.

Optionally, in embodiments of this disclosure, the network device and the terminal may communicate over a licensed spectrum, may communicate over an unlicensed spectrum, or may communicate over both a licensed spectrum and an unlicensed spectrum. Embodiments of this disclosure are applicable to a low frequency (sub-6 GHz) scenario, and are also applicable to a high frequency (above 6 GHz) scenario, terahertz, optical communication, and the like. For example, the network device and the terminal may communicate over a spectrum below 6 gigahertz (GHz), may communicate over a spectrum above 6 GHz, or may communicate over both a spectrum below 6 GHz and a spectrum above 6 GHz. A spectrum resource used between the network device and the terminal is not limited in embodiments of this disclosure.

In embodiments of this disclosure, the higher layer signaling may be at least one of RRC signaling, MAC signaling, RLC signaling, or the like. In this disclosure, RRC signaling is used as an example for description. The RRC signaling may be higher layer signaling, and may be replaced with the foregoing examples of higher layer signaling. This is not limited in this disclosure.

In embodiments of this disclosure, physical layer signaling may be at least one of downlink control information (DCI), receive control information (RxCI), uplink control information (UCI), transmit control information (TxCI), or the like. In this disclosure, DCI is used as an example for description. The DCI may be physical layer signaling, and may be replaced with the foregoing examples of physical layer signaling. This is not limited in this disclosure.

A communication method in embodiments of this disclosure may be applied to communication between a network device and a terminal device, communication between network devices, or communication between terminal devices. It should be noted that the following embodiments are described by using a first communication apparatus and a second communication apparatus as an example. The first communication apparatus may be a network device or a terminal device. The second communication apparatus may be a network device or a terminal device.

FIG. 1 is a schematic block diagram of an example communication system 100 to which embodiments of this disclosure are applicable. As shown in the figure, the communication system 100 may include a first communication apparatus 110, a second communication apparatus 120, and a third communication apparatus 130. Embodiments of this disclosure are also applicable to a communication system that includes only the first communication apparatus 110 and the second communication apparatus 120. This is not specifically limited in this disclosure.

In some implementations, the communication system 100 may be implemented as a satellite communication system. In such embodiments, the first communication apparatus 110 and the third communication apparatus 130 each may be implemented as a terminal device, and the second communication apparatus 120 may be implemented as a satellite base station. The satellite base station may be an unmanned aerial vehicle, a hot air balloon, a low Earth orbit satellite, a medium Earth orbit satellite, a high Earth orbit satellite, or the like. The satellite base station may alternatively be a non-terrestrial base station, a non-terrestrial device, or the like. The terminal device may include a smartphone, a smart watch, a tablet computer, a personal digital assistant (PDA), a vehicle-mounted mobile apparatus, and the like. The satellite base station may provide a communication service for the terminal device. The satellite base station may transmit downlink data to the terminal device. The terminal device may transmit uplink data to the satellite base station. The satellite base station may also communicate with a base station (not shown in FIG. 1).

In some implementations, the communication system 100 may be implemented as an inter-satellite link communication system. In such embodiments, the first communication apparatus 110, the second communication apparatus 120, and the third communication apparatus 130 each may be implemented as a satellite.

In some other embodiments, the communication system 100 may be implemented as a cellular communication system. In such an embodiment, the first communication apparatus 110 and the third communication apparatus 130 each may be implemented as a terminal device, and the second communication apparatus 120 may be implemented as a network device. The cellular communication system usually includes cells. Each cell includes a network device. The network device provides communication services for a plurality of terminal devices.

Examples of the cellular communication system may include but are not limited to an NB-IoT system, a long term evolution (LTE) system, and a 5G mobile communication system that has three major application scenarios: eMBB, URLLC, and mMTC.

URLLC is one of the three major application scenarios of 5G. As a breakthrough for the mobile communication industry to enter vertical industries, URLLC is critical for wide disclosure in fields such as autonomous driving, industrial manufacturing, internet of vehicles, and smart grid. Most significant features of the URLLC scenario are low latency and high reliability. There is a broad range of URLLC scenarios, and different scenarios have different requirements for a latency, reliability, and a bandwidth.

Specifically, the URLLC scenarios may include at least “three-remote” scenarios in power automation, an internet of vehicles scenario, and an industrial manufacturing scenario, where the industrial manufacturing scenario has most challenging requirements for a low latency and high reliability. In the industrial manufacturing scenario, a manufacturing device of a smart factory is connected to an enterprise cloud or an on-site control system through 5G, to collect on-site environment data and production data and analyze a production condition in real time. In this way, a fully unmanned and wireless production line is implemented. Intelligent industrial manufacturing has a very high requirement for technical performance, and high-end manufacturing has extremely high requirements for a latency and stability of a workshop device. In addition, the factory needs a large quantity of device chips, and reducing costs is also critical.

Although the foregoing mainly describes the industrial manufacturing scenario, this does not mean that the solutions in this disclosure are not applicable to another scenario having a URLLC requirement. The solutions in this disclosure are also applicable to another service scenario having requirements for a low latency and high reliability. In addition, this disclosure is not limited to being applicable to only a URLLC service scenario, but is also applicable to another service scenario. This is not limited in this disclosure.

In some other embodiments, the communication system 100 may be implemented as a wireless projection system. In such embodiments, the first communication apparatus 110 and the third communication apparatus 130 each may be implemented as a terminal device, and the second communication apparatus 120 may be implemented as a television.

In some other embodiments, the communication system 100 may be implemented as an integrated access and backhaul (IAB) system. For a backhaul link and an access link, the IAB system implements integration of access and backhaul. In such embodiments, the first communication apparatus 110 may be implemented as a terminal device, the second communication apparatus 120 may be implemented as an IAB donor, and the third communication apparatus 130 may be implemented as an IAB node. A link between the IAB donor and the IAB node is a backhaul link, and a link between the terminal device and the IAB node is an access link.

As described above, the terminal device needs to send a preamble sequence on a PRACH to initiate an initial access process, and the terminal device needs to send an SRS to implement uplink synchronization. In other words, different types of signals need to be used for different communication procedures. As a result, processing complexity of the terminal device is relatively high, chip costs are relatively high, and large-scale commercial use cannot be implemented.

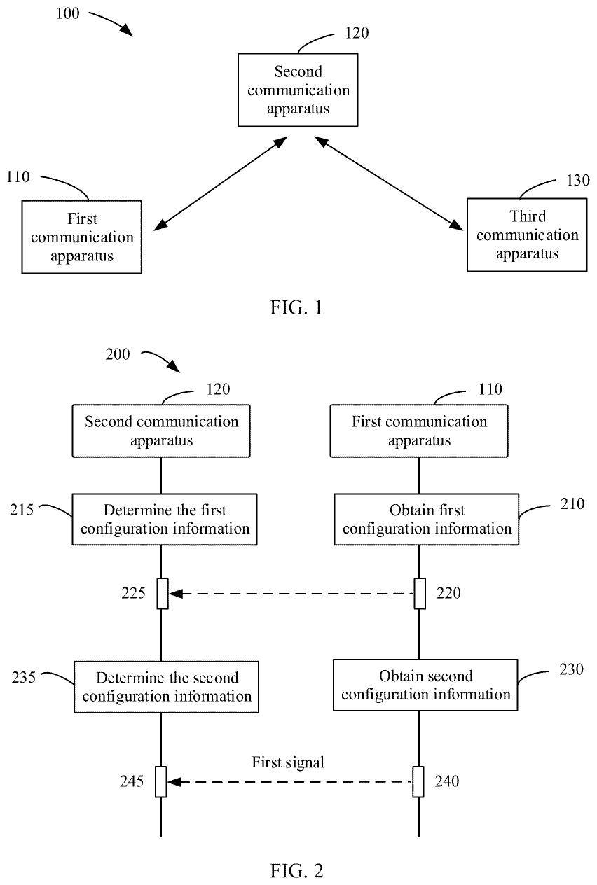

To resolve the foregoing problem, this disclosure provides a communication solution. According to the communication solution, a first communication apparatus obtains first configuration information and second configuration information that are of a first signal, where the first configuration information and the second configuration information are respectively associated with a first communication procedure and a second communication procedure of the first communication apparatus. Then, the first communication apparatus sends the first signal based on at least one of the first configuration information or the second configuration information. In this way, the first communication apparatus can use a same type of signals to perform different communication procedures. This reduces processing complexity, and can further reduce chip costs of the first communication apparatus and improve resource utilization. The following describes implementations of this disclosure in detail with reference to FIG. 2 to FIG. 13.

FIG. 2 is a signaling interaction diagram of a communication method 200 according to some embodiments of this disclosure. For ease of discussion, the method 200 is discussed with reference to the communication system 100 in FIG. 1. The method 200 relates to the first communication apparatus 110 in FIG. 1. In some implementations, the method 200 may further relate to at least one of the second communication apparatus 120 or the third communication apparatus 130. However, it should be understood that the method 200 may also be performed between communication apparatuses in any other communication scenario.

As shown in FIG. 2, the first communication apparatus 110 obtains (210) first configuration information of a first signal. The first configuration information is associated with a first communication procedure of the first communication apparatus 110. Correspondingly, the second communication apparatus 120 determines (215) the first configuration information of the first signal.

The first communication apparatus 110 obtains (230) second configuration information of the first signal. The second configuration information is associated with a second communication procedure of the first communication apparatus 110. Correspondingly, the second communication apparatus 120 determines (235) the second configuration information of the first signal.

Then, the first communication apparatus 110 sends the first signal based on at least one of the first configuration information or the second configuration information. Correspondingly, the second communication apparatus 120 receives the first signal based on the at least one of the first configuration information or the second configuration information.

In some implementations, optionally, the first communication apparatus 110 may send (220) the first signal based on the first configuration information. Correspondingly, the second communication apparatus 120 may receive (225) the first signal based on the first configuration information.

In some implementations, optionally, the first communication apparatus 110 may send (240) the first signal based on the second configuration information. Correspondingly, the second communication apparatus 120 may receive (245) the first signal based on the second configuration information.

It may be understood that although it is shown in FIG. 2 that the action 230 is performed after the action 210, this is merely an example. In another example, the action 210 and the action 230 may be performed in parallel, or the action 210 and the action 230 may be combined into one action. In other words, the first communication apparatus 110 simultaneously obtains the first configuration information and the second configuration information. Similarly, although it is shown in FIG. 2 that the action 230 is performed after the action 220, this is merely an example. In another example, the action 220 may be performed after the action 230. The scope of this disclosure is not limited in this respect.

In some implementations, the first communication procedure may be initial access, and the second communication procedure may be at least one of the following: uplink synchronization; channel sounding between the first communication apparatus 110 and the second communication apparatus 120; beam selection for communication between the first communication apparatus 110 and the second communication apparatus 120; or beam recovery for communication between the first communication apparatus 110 and the second communication apparatus 120. In such embodiments, the first communication apparatus 110 may send the first signal based on the first configuration information, for initial access of the first communication apparatus 110; or the first communication apparatus 110 may send the first signal based on the second configuration information, for channel sounding, beam selection, or beam recovery. In this way, the first communication apparatus 110 can use a same type of signals to perform initial access and perform channel sounding, beam selection, or beam recovery. In some implementations, the same type of signals may include but are not limited to a same type of sequences. In some implementations, different root sequences, different cyclic shifts, and/or the like may be used for sequences used for different communication procedures.

Because the same type of signals are used for initial access, and channel sounding, beam selection, or beam recovery, the first communication apparatus 110 can use a same signal processing method for different communication procedures. This reduces processing complexity of the first communication apparatus 110, and can further reduce chip costs of the first communication apparatus 110, thereby facilitating large-scale commercial use. In addition, a resource for initial access can be used for channel sounding, beam selection, or beam recovery. This improves resource utilization.

In some implementations, the first signal may include one of a preamble sequence and an SRS.

As described above, the solutions in this disclosure may be applied to an industrial manufacturing scenario. In this scenario, a radius of a factory is relatively small. Therefore, the SRS may be used for initial access, to reduce an access latency and meet a URLLC requirement of this scenario.

In some implementations, the first configuration information and/or the second configuration information may indicate at least one of the following parameters: a subcarrier spacing of the first signal; a cyclic prefix (CP) length of the first signal; a time-domain length of the first signal; a quantity of combs of the first signal; a time-domain resource of the first signal; a frequency-domain resource of the first signal; a signal sequence of the first signal; or information associated with generation of the signal sequence.

In some implementations, the first communication apparatus 110 may obtain the first configuration information by receiving the first configuration information from the second communication apparatus 120. The following uses an example in which the first communication procedure is initial access and the second communication procedure is channel sounding for description.

In such an embodiment, the second communication apparatus 120 sends the first configuration information to the first communication apparatus 110, and the first communication apparatus 110 sends the first signal based on the first configuration information, for initial access.

Specifically, an example of an initial access procedure is as follows:
Step 1: The second communication apparatus sends the first configuration information, and correspondingly, the first communication apparatus obtains the first configuration information.
Step 2: The first communication apparatus sends the first signal based on the first configuration information, and correspondingly, the second communication apparatus receives the first signal.
Step 3: The second communication apparatus obtains initial access information of the first communication apparatus based on the first signal.

Optionally, the initial access information includes a synchronization timing, a terminal identifier, and the like.

The first configuration information may indicate at least one of the following parameters:

### First Subcarrier Spacing

The first subcarrier spacing may be S kHz, where S is a positive integer. For example, the first subcarrier spacing may be 15 kHz, 30 kHz, 45 kHz, 60 kHz, 75 kHz, 120 kHz, or the like.

### First CP Length

The first CP length may be C₁₁ us or P₁₁ Tₛ, where C₁₁ and P₁₁ are integers. For example, the first CP length may be 1 μs, 3 μs, 5 μs, 10 μs, 15 μs, 600 Tₛ, 1000 Tₛ, or the like. Tₛ is sampling time for an orthogonal frequency division multiplexing (OFDM) symbol with a fast Fourier transform size of 2048 points. Tₛ=1/(15000 Hz×2048).

### First Sequence Length of the First Signal, First Time-Domain Length of the First Signal, First Quantity of Symbols of the First Signal, or the Like

The first quantity of symbols of the first signal may be B1, where B1 is a positive integer. For example, the first quantity of symbols of the first signal may be 1, 2, 4, or the like. For example, the first sequence length of the first signal or the first time-domain length of the first signal may be C₁₂ μs or P₁₂ Tₛ, where C₁₂ and P₁₂ are integers. For example, the first sequence length of the first signal or the first time-domain length of the first signal may be 30 μs, 60 μs, 6000 Tₛ, 12000 Tₛ, or the like.

### First Time-Domain Resource

The first time-domain resource may indicate a subframe, a slot, a symbol, and/or the like in which the first signal is located. For example, the first time-domain resource may indicate a symbol index l, where l is an integer.

### First Frequency-Domain Resource

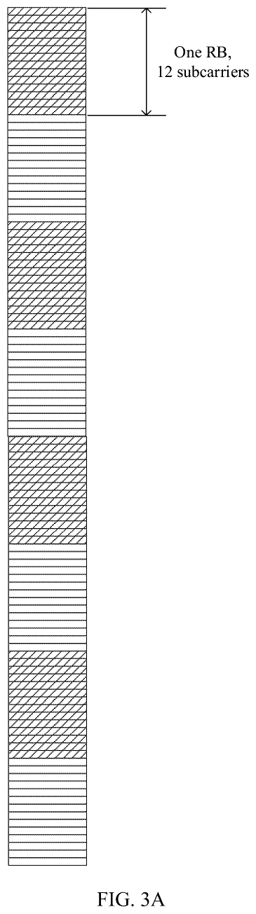

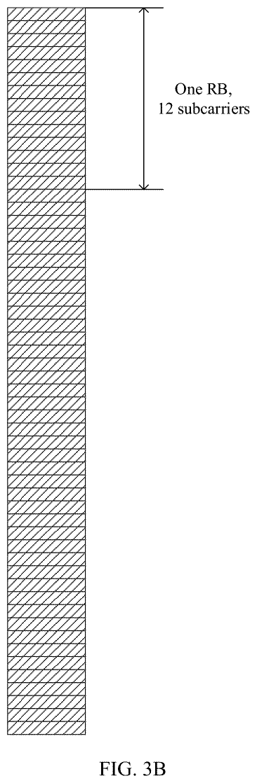

The first frequency-domain resource may indicate a position of a starting resource block (RB) and a total quantity of contiguous RBs. As an example, the first frequency-domain resource may indicate an index b (b is an integer) of the starting RB, and may indicate that the total quantity of contiguous RBs is 4. For example, as shown in FIG. 3B, the first communication apparatus 110 transmits the first signal on four contiguous RBs.

Alternatively, the first frequency-domain resource may indicate at least one of a position of a starting RB, a quantity of spacing RBs, or a total quantity of RBs. For example, the first frequency-domain resource may indicate an index b (b is an integer) of the starting RB, and may indicate that the quantity of spacing RBs is 1, 2, 4, or 8, and the total quantity of RBs is 4. In an example in which the quantity of spacing RBs is 2, the first communication apparatus 110 sends the first signal at an interval of two RBs. In other words, the first signal is transmitted on one of every three RBs. In an example in which the quantity of spacing RBs is 4, the first communication apparatus 110 sends the first signal at an interval of four RBs. In other words, the first signal is transmitted on one of every five RBs. In an example in which the quantity of spacing RBs is 8, the first communication apparatus 110 sends the first signal at an interval of eight RBs. In other words, the first signal is transmitted on one of every nine RBs. For example, as shown in FIG. 3A, the first communication apparatus 110 transmits the first signal at an interval of one RB, and a total quantity of RBs on which the first signal is transmitted is 4.

### First Quantity of Combs

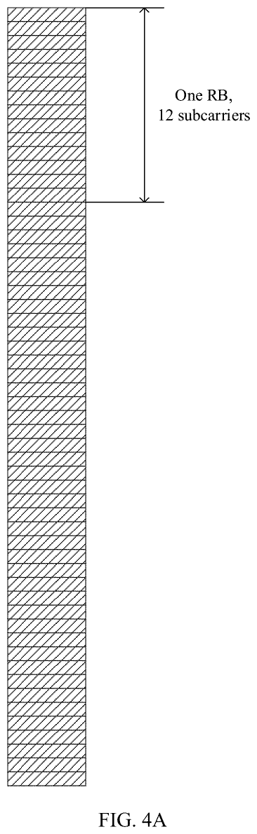

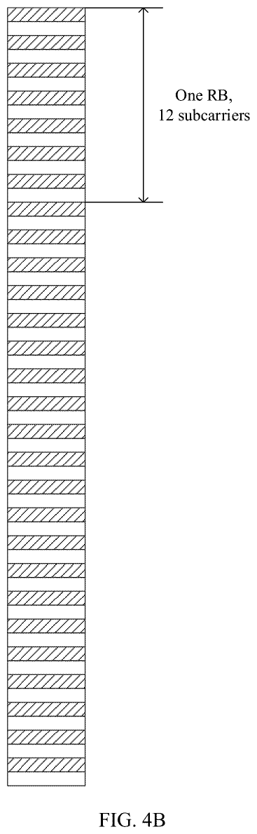

The first quantity of combs may be 1, 2, 4, 8, or the like. In an example in which the first quantity of combs is 1, the first communication apparatus 110 maps the first signal to contiguous subcarriers for sending, as shown in FIG. 4A. In an example in which the first quantity of combs is 2, the first communication apparatus 110 maps the first signal at an interval of one subcarrier. For example, as shown in FIG. 4B, when the first quantity of combs is 2, the first signal is transmitted on only subcarriers with shading lines or transmitted on only subcarriers without shading lines. In an example in which the first quantity of combs is 4, the first communication apparatus 110 maps the first signal at an interval of three subcarriers. In an example in which the first quantity of combs is 8, the first communication apparatus 110 maps the first signal at an interval of seven subcarriers.

In some implementations, the second communication apparatus 120 may separately indicate or jointly indicate the foregoing parameters. As an example, a correspondence between items in Table 1 may be predefined. The correspondence may include one or more rows in the table, and/or the correspondence may include one or more columns in the table.

Optionally, the second communication apparatus 120 may indicate at least two of the foregoing parameters in Table 1 by using the correspondence. For example, the second communication apparatus 120 may indicate a “number” in Table 1 to indicate a parameter corresponding to the number.

TABLE 1

| | | | Sequence length/Time- | |
|---|---|---|---|---|
| | Subcarrier | CP | domain length/ | Time-frequency- |
| Number | spacing | length | Quantity of symbols | domain resource |
| 0 | 15 kHz | 6 μs | One symbol | RBs 4 to 7, and |
| | | | | symbol 0 |
| 1 | 30 kHz | 3 μs | Two symbols | RBs 20 to 27, and |
| | | | | symbols 1 and 2 |
| . . . | . . . | . . . | . . . | . . . |
| L − 1 | S kHz | C₁ μs or | B or C₂ μs | RB index b |
| | | P₁ Tₛ | | Symbol index 1 |

In some implementations, optionally, the second communication apparatus 120 may determine a newly added user in a cell based on sensing, to determine a requirement status of a resource of a first signal. This facilitates configuration of a time-frequency resource, a sequence, and/or the like of the first signal.

In some implementations, optionally, the first configuration information may be carried in system information for transmission. For example, the first configuration information may be transmitted in a system information block 1 (SIB1), namely, remaining minimum system information (RMSI). Alternatively, the first configuration information may be transmitted through common radio resource control (RRC) signaling or dedicated RRC signaling, or higher layer signaling. Alternatively, the first configuration information may be transmitted through physical layer signaling. Examples of the physical layer signaling may include but are not limited to RxCI transmitted on a physical reception link control channel (PRxCCH) and DCI transmitted on a physical downlink control channel (PDCCH).

In some implementations, the first communication apparatus 110 may obtain the second configuration information by receiving the second configuration information from the second communication apparatus 120. The following uses an example in which the first communication procedure is initial access and the second communication procedure is channel sounding for description.

In such an embodiment, the second communication apparatus 120 sends the second configuration information to the first communication apparatus 110, and the first communication apparatus 110 sends the first signal based on the second configuration information, for channel sounding.

Specifically, an example of a channel sounding procedure is as follows:
Step 1: The second communication apparatus sends the second configuration information, and correspondingly, the first communication apparatus obtains the second configuration information.
Step 2: The first communication apparatus sends the first signal based on the second configuration information, and correspondingly, the second communication apparatus receives the first signal.
Step 3: The second communication apparatus obtains channel information, that is, performs channel sounding, based on the first signal.

The second configuration information may indicate at least one of the following parameters:

### Second Subcarrier Spacing

The second subcarrier spacing may be S kHz, where S is a positive integer. For example, the second subcarrier spacing may be 15 kHz, 30 kHz, 45 kHz, 60 kHz, 75 kHz, 120 kHz, or the like.

### Second CP Length

The second CP length may be C₂₁ μs or P₂₁ Tₛ, where C₂₁ and P₂₁ are integers. For example, the second CP length may be 1 μs, 3 μs, 5 μs, 10 μs, 15 μs, 600 Tₛ, 1000 Tₛ, or the like.

### Second Sequence Length of the First Signal, Second Time-Domain Length of the First Signal, Second Quantity of Symbols of the First Signal, or the Like

The second quantity of symbols of the first signal may be B2, where B2 is a positive integer. For example, the second quantity of symbols of the first signal may be 1, 2, 4, or the like. For example, the second sequence length of the first signal or the second time-domain length of the first signal may be C₂₂ μs or P₂₂ Tₛ, where C₂₂ and P₂₂ are integers. For example, the second sequence length of the first signal or the second time-domain length of the first signal may be 30 μs, 60 μs, 6000 Tₛ, 12000 Tₛ, or the like.

### Second Time-Domain Resource

The second time-domain resource may indicate a subframe, a slot, a symbol, and/or the like in which the first signal is located. For example, the second time-domain resource may indicate a symbol index l, where l is an integer.

### Second Frequency-Domain Resource

The second frequency-domain resource may indicate a position of a starting RB and a total quantity of contiguous RBs. As an example, the second frequency-domain resource may indicate an index b (b is an integer) of the starting RB, and may indicate that the total quantity of contiguous RBs is 4.

Alternatively, the second frequency-domain resource may indicate a position of a starting RB, a quantity of spacing RBs, and a total quantity of RBs. For example, the second frequency-domain resource may indicate an index b (b is an integer) of the starting RB, and may indicate that the quantity of spacing RBs is 1, 2, 4, or 8, and the total quantity of RBs is 4. In an example in which the quantity of spacing RBs is 2, the first communication apparatus 110 sends the first signal at an interval of two RB. In other words, the first signal is transmitted on one of every three RBs. In an example in which the quantity of spacing RBs is 4, the first communication apparatus 110 sends the first signal at an interval of four RBs. In other words, the first signal is transmitted on one of every five RBs. In an example in which the quantity of spacing RBs is 8, the first communication apparatus 110 sends the first signal at an interval of eight RBs. In other words, the first signal is transmitted on one of every nine RBs.

### Second Quantity of Combs

The second quantity of combs may be 1, 2, 4, 8, or the like. In an example in which the second quantity of combs is 1, the first communication apparatus 110 maps the first signal to contiguous subcarriers for sending. In an example in which the second quantity of combs is 2, the first communication apparatus 110 maps the first signal at an interval of one subcarrier. In an example in which the second quantity of combs is 4, the first communication apparatus 110 maps the first signal at an interval of three subcarriers. In an example in which the second quantity of combs is 8, the first communication apparatus 110 maps the first signal at an interval of seven subcarriers.

In some implementations, the second communication apparatus 120 may separately indicate or jointly indicate the foregoing parameters. As an example, a correspondence between items in Table 1 may be predefined. The correspondence may include one or more rows in the table, and/or the correspondence may include one or more columns in the table.

Optionally, the second communication apparatus 120 may indicate at least two of the foregoing parameters in Table 1 by using the correspondence. For example, the second communication apparatus 120 may indicate a “number” in Table 1 to indicate a parameter corresponding to the number.

In some implementations, a value of the parameter indicated by the first configuration information may be the same as a value of the parameter indicated by the second configuration information.

For example, the subcarrier spacing, the CP length, and the time-domain length of the first signal that are indicated by the first configuration information may be respectively the same as the subcarrier spacing, the CP length, and the time-domain length of the first signal that are indicated by the second configuration information.

In some other embodiments, a value of the parameter indicated by the first configuration information may be different from a value of the parameter indicated by the second configuration information. For example, in an embodiment in which the first communication procedure is initial access and the second communication procedure is channel sounding, the first configuration information may indicate that the quantity of combs is 1, frequency-domain resources are an RB0, an RB2, an RB4, and an RB6, and the signal sequence is a sequence 1, and the second configuration information may indicate that the quantity of combs is 2, frequency-domain resources are an RB1, an RB3, an RB5, and an RB7, and the signal sequence is a sequence 2.

Optionally, the first signal may be referred to as an integrated access and sounding reference signal (IAS-RS). The first signal may be a signal used for initial access and channel sounding.

Optionally, the first configuration information may indicate the associated first communication procedure, and the second configuration information may indicate the associated second communication procedure. For example, a name of the first configuration information may indicate that the first signal is used for initial access, and a name of the second configuration information may indicate that the first signal is used for channel sounding, beam selection, or beam recovery. Therefore, the first communication apparatus 110 may determine, based on a name of configuration information, a communication procedure associated with the configuration information.

For example, the first configuration information is IAS-RS-Resource-ForInitialAccess, and the second configuration information is IAS-RS-Resource-ForBeamSelection or IAS-RS-Resource-ForChannelsounding.

According to embodiments of this disclosure, a communication method for unified access may be implemented. In a URLLC factory scenario, a same type of signals (for example, SRSs) may be used to perform initial access and channel sounding. A resource for initial access may be used by the first communication apparatus to perform channel sounding. This improves resource utilization. In addition, a same type of signals are used for initial access and channel sounding so that complexity of the first communication apparatus can be reduced. Besides, the first communication apparatus can also support first signals with a plurality of CP lengths (configurable), to implement functions of initial access, uplink synchronization, and channel sounding. Different communication procedures may correspond to transmission of signals with different CP lengths.

In some implementations, it is considered that initial access may be initial access based on a preamble sequence, or may be random access based on the first signal in the solutions of this disclosure. Therefore, the second communication apparatus 120 may indicate the first communication apparatus 110 to use a specific initial access manner, for example, to perform initial access based on a preamble sequence or based on the first signal, to implement backward compatibility.

Optionally, the second communication apparatus may send first indication information to the first communication apparatus. The first indication information indicates an initial access manner of the first communication apparatus. The initial access manner may be performing initial access based on the preamble sequence or performing initial access based on the first signal.

In some implementations, the first indication information may be indicated in system information (for example, a SIB1 or RMSI), or may be indicated by other signaling. The scope of this disclosure is not limited in this aspect.

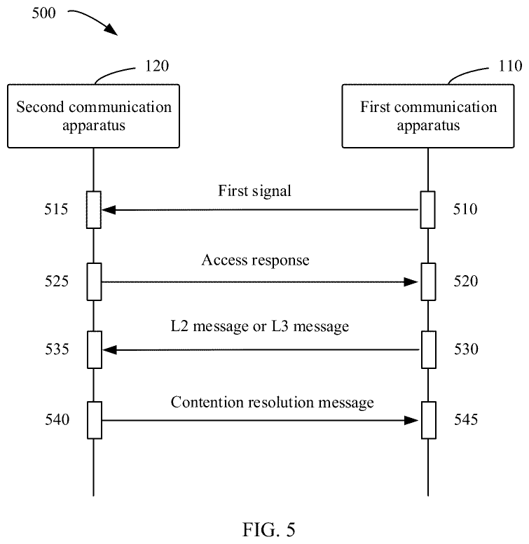

As described above, the first communication apparatus 110 may send the first signal based on the first configuration information, for initial access. In some implementations, the initial access may be contention-based initial access. The following provides a detailed description with reference to FIG. 5.

FIG. 5 is a signaling interaction diagram of a communication method 500 according to some embodiments of this disclosure. For ease of discussion, the method 500 is discussed with reference to the communication system 100 in FIG. 1. The method 500 relates to the first communication apparatus 110 and the second communication apparatus 120 in FIG. 1. The method 500 may be understood as an example implementation of the method 200. However, it should be understood that the method 500 may also be performed between communication apparatuses in any other communication scenario.

As shown in FIG. 5, the first communication apparatus 110 sends (510) a first signal to the second communication apparatus 120. Correspondingly, the second communication apparatus 120 receives (515) the first signal from the first communication apparatus 110. The second communication apparatus 120 sends (525) a random access response to the first communication apparatus 110. Correspondingly, the first communication apparatus 110 receives (520) the random access response from the second communication apparatus 120. The first communication apparatus 110 sends (530) a layer 2 (L2) message or a layer 3 (L3) message to the second communication apparatus 120. Correspondingly, the second communication apparatus 120 receives (535) the layer 2 (L2) message or the layer 3 (L3) message from the first communication apparatus 110. Then, the second communication apparatus 120 sends (540) a contention resolution message to the first communication apparatus 110. Correspondingly, the first communication apparatus 110 receives (545) the contention resolution message from the second communication apparatus 120.

In some implementations, the second communication apparatus 120 may configure a contention-based initial access parameter by using system information. For example, first configuration information may indicate the contention-based initial access parameter. In some implementations, an initial access parameter may indicate a frequency-domain occasion of the first signal by indicating at least one of the following information:
a quantity of RBs included in each frequency-domain occasion;
an occasion number (a quantity of occasions or an occasion index);
a total quantity of RBs;
a total quantity of frequency-domain occasions; or
a frequency-domain starting position of the first signal.

In some implementations, the second communication apparatus 120 may send carrier configuration information. The carrier configuration information may indicate at least one of a frequency-domain starting position point of a carrier, a carrier offset, or a bandwidth of the carrier.

In some implementations, the second communication apparatus 120 may send BWP configuration information. The BWP configuration information may indicate at least one of a starting position of a BWP or a size of the BWP.

In some implementations, optionally, the second communication apparatus 120 may send at least one of the carrier configuration information or the BWP configuration information in the first configuration information. Alternatively, the second communication apparatus 120 may send at least one of the carrier configuration information or the BWP configuration information independently of the first configuration information.

In some implementations, the first communication apparatus 110 may determine the at least one of the frequency-domain starting position point of the carrier, the carrier offset, or the bandwidth of the carrier based on the carrier configuration information received from the second communication apparatus 120.

In some implementations, alternatively, the first communication apparatus 110 may determine, based on a synchronization signal block (SSB) received from the second communication apparatus 120, a center frequency (also referred to as a reference point) of the SSB. Then, the first communication apparatus 110 may determine a frequency-domain starting position point of a carrier based on the center frequency of the SSB and a carrier offset.

In some implementations, the first communication apparatus 110 may determine the at least one of the starting position of the BWP or the size of the BWP based on the BWP configuration information received from the second communication apparatus 120.

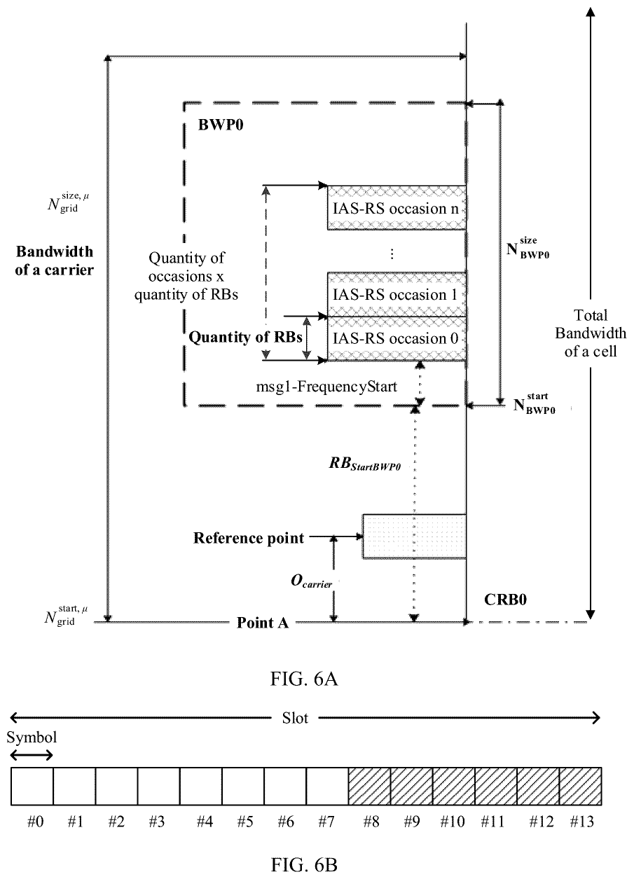

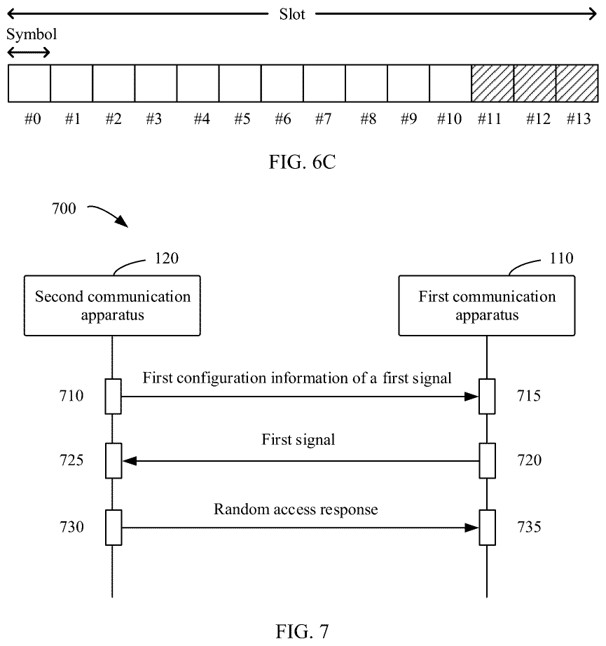

FIG. 6A shows an example of contention-based initial access parameters. As shown in FIG. 6A, the first communication apparatus 110 receives a synchronization signal block (SSB). The first communication apparatus 110 may determine, based on the received SSB, a center frequency of the SSB. The center frequency of the SSB is represented by a reference point. The first communication apparatus 110 may determine, based on the center frequency of the SSB and a carrier offset O_{carrier} configured by the second communication apparatus 120, a frequency-domain starting position point A (represented by N_{grid}^{start,μ} and corresponding to a grid common resource block 0 (CRB0)) of a carrier. Alternatively, the first communication apparatus 110 may receive information about a frequency-domain starting position point A of a carrier from the second communication apparatus 120. The first communication apparatus 110 may receive information about a bandwidth (N_{grid}^{size,μ}) of the carrier from the second communication apparatus 120.

The second communication apparatus 120 may send BWP configuration information to the first communication apparatus 110 on the carrier. For example, the BWP configuration information may indicate a BWP0. A starting position of the BWP0 is represented by N_{BWP0}^{start}, and a size of the BWP0 is represented by N_{BWP0}^{size}. The second communication apparatus 120 may configure the frequency-domain starting position of the first signal for the first communication apparatus 110, to indicate a frequency-domain starting position of the first signal in the BWP0. The frequency-domain starting position of the first signal in the BWP0 is represented by msg1-FrequencyStart. In other words, the second communication apparatus 120 may indicate to start allocating frequency-domain occasions, for example, an IAS-RS occasion 0, an IAS-RS occasion 1, . . . , and an IAS-RS occasion n (n is a natural number), from an RB that is indicated by msg1-FrequencyStart and that is in the BWP0.

Optionally, the second communication apparatus 120 may further configure, for the first communication apparatus 110, a quantity of RBs included in one frequency-domain occasion of the first signal, for example, represented by RB quantity. For example, the quantity of RBs included in one frequency-domain occasion of the first signal is two, four, eight, or the like. The second communication apparatus 120 may further configure, for the first communication apparatus 110, a total quantity of frequency-domain occasions of the first signal, for example, represented by frequency occasion number. For example, the total quantity of frequency-domain occasions of the first signal is n+1. Alternatively, the second communication apparatus 120 may configure a total quantity N1 of RBs in frequency domain, namely, the total quantity of RBs. In this case, the total quantity of frequency-domain occasions satisfies frequency occasion number=N1/Quantity of RBs.

In some implementations, a parameter that is not configured may be predefined, that is, known to both the second communication apparatus 120 and the first communication apparatus 110.

In some implementations, an initial access parameter may indicate a time-domain occasion of the first signal by indicating at least one of the following information:
a time-domain starting symbol;
a quantity of occasions in each slot;
a slot number in each subframe; or
a subframe number.

FIG. 6B and FIG. 6C each show an example of contention-based initial access parameters. As shown in FIG. 6B, the second communication apparatus 120 may configure, for the first communication apparatus 110, a time-domain starting symbol of the first signal, for example, represented by starting symbol, to indicate a time-domain starting symbol of the first signal in a slot. In the example shown by FIG. 6B, the second communication apparatus 120 may configure, for the first communication apparatus 110, a subcarrier spacing of 15 kHz and an indication indicating that the first signal occupies last six symbols in the slot. For example, symbol numbers are #8 to #13. Alternatively, the second communication apparatus 120 may configure, for the first communication apparatus 110, a subcarrier spacing of 30 kHz and an indication indicating that the first signal occupies last three symbols in a slot. For example, symbol numbers are #11 to #13, as shown in FIG. 6C.

The second communication apparatus 120 may configure, for the first communication apparatus 110, a quantity of symbols included in each time-domain occasion of the first signal, for example, represented by symbol quantity. The second communication apparatus 120 may configure, for the first communication apparatus 110, a total quantity of time-domain occasions of the first signal in one time unit, for example, represented by time occasion quantity. The time unit may be a slot, a subframe, a radio frame, or the like. Alternatively, the second communication apparatus 120 may configure a total quantity (for example, represented by N2) of symbols in time domain for the first communication apparatus 110. In this case, the total quantity of time-domain occasions satisfies time occasion quantity=N2/symbol quantity. The second communication apparatus 120 may also indicate a slot number, a subframe number, and the like when configuring a time-domain occasion.

In some implementations, a parameter that is not configured may be predefined, that is, known to both the second communication apparatus 120 and the first communication apparatus 110.

As described above, in some implementations, the first configuration information and/or the second configuration information may indicate information associated with generation of a signal sequence of the first signal.

In some implementations, the information associated with generation of the signal sequence of the first signal may include at least one of the following:
a sequence group number;
a sequence number;
a sequence identity of the first signal;
a cyclic shift; or
a quantity of combs (comb quantity).

In some implementations, the signal sequence of the first signal may be generated by using the following method.

Optionally, the second communication apparatus 120 may configure a sequence group number of the first signal for the first communication apparatus 110, for example, configures group number, to indicate a sequence group number used for generation of the signal sequence of the first signal.

Optionally, the second communication apparatus 120 may configure a sequence number of the first signal for the first communication apparatus 110, for example, configures sequence number, to indicate a sequence number used for generation of the signal sequence of the first signal. For example, the second communication apparatus 120 may send higher layer signaling to the first communication apparatus 110. The higher layer signaling may include hopping information. For example, the hopping information may be a higher layer parameter groupOrSequence Hopping. The higher layer parameter may be used to determine the sequence number of the first signal.

Optionally, the second communication apparatus 120 may configure a sequence identity of the first signal for the first communication apparatus 110, for example, configures sequence ID, to indicate a sequence identity used for generation of the signal sequence of the first signal.

Optionally, the second communication apparatus 120 may configure a cyclic shift of the first signal for the first communication apparatus 110, for example, configures cyclic shift.

Optionally, the second communication apparatus 120 may configure a quantity of combs (comb quantity) of the first signal for the first communication apparatus 110. For example, the second communication apparatus 120 may send higher layer signaling to the first communication apparatus 110. The higher layer signaling may include a higher layer parameter transmissionComb, and the higher layer parameter may indicate the quantity of combs of the first signal.

In some implementations, a parameter that is not configured may be predefined, that is, known to both the second communication apparatus 120 and the first communication apparatus 110.

In some implementations, the signal sequence of the first signal may be generated according to the following formula:

$${r}^{( {p}_{i} )} ( n , {l}^{′} ) = {r}_{u , v}^{( {a}_{i} , δ )} ( n )$$

0≤n≤ M_{sc,b}^{IAS-RS}−1 and l′∈{0, 1, . . . , N_{symb}^{IAS-RS}−1}. M_{sc,b}^{IAS-RS} represents an RB length of the signal sequence of the first signal. r_{u,v}^{(α}^{ᵢ}^{,δ)}(n) is determined according to r_{u,v}^{(α}^{ᵢ}^{,δ)} (n)=e^{jα}^{ᵢ}ⁿr̅_{u,v}(n), 0≤n≤M_{ZC}. M_{ZC}=mN_{sc}^{RB}/2^{δ} represents a sequence length. δ=log₂(K_{TC}). The quantity of combs (comb quantity) K_{TC}∈{2, 4, 8}. pᵢ represents an antenna port number. r̅_{u,v}(n) represents a base sequence. m represents an RB number. n represents the sequence number. N_{symb}^{IAS-RS} represents a total quantity of symbols of the first signal. N_{sc}^{RB} represents a quantity of subcarriers in one RB.

The base sequence r̅_{u,v}(n) is divided into a plurality of groups. u∈{0, 1 . . . , 29} represents a group number. v represents a sequence number within a group. Each sequence includes one base sequence (v=0) of each length is M_{ZC}=mN_{sc}^{RB}/2^{δ}, ½≤m/2^{δ}≤5. Alternatively, each sequence whose length is M_{ZC}=mN_{sc}^{RB}/2^{δ} in each group includes two base sequences (v=0,1), and 6≤m/2^{δ}. The base sequence r̅_{u,v}(0), . . . , r̅_{u,v}(M_{ZC}−1) may have different definitions based on different sequence lengths M_{ZC}.

A cyclic shift αᵢ for an antenna port pᵢ may be determined according to the following formulas:

$$\begin{matrix}{α}_{i} = 2 π \frac{{n}_{SRS}^{cs , i}}{{n}_{SRS}^{cs , max}} \\ {n}_{SRS}^{cs , i} = ( {n}_{SRS}^{c s} + \frac{{n}_{SRS}^{cs , max} ( {p}_{i} - 1000 )}{{N}_{a p}^{SRS}} ) mod {n}_{SRS}^{cs , max}\end{matrix}$$

n_{SRS}^{cs}∈{0, 1 . . . , n_{SRS}^{cs,max}−1} is configured by using the higher layer parameter transmissionComb. A maximum quantity n_{SRS}^{cs,max} of cyclic shifts may be determined according to Table 2.

TABLE 2

| K_{TC} | n_{SRS}^{cs, max} |
|---|---|
| 2 | 8 |
| 4 | 12 |
| 8 | 6 |

The sequence group number u=(f_{gh}(n_{s,f}^{μ}, l′)+n_{ID}^{SRS}) mod 30. The sequence number v may be determined based on the higher layer parameter groupOrSequenceHopping.

The second communication apparatus 120 may configure an IAS-RS sequence identity n_{ID}^{IAS-RS} for the first communication apparatus 110, for example, by using a higher layer parameter sequenceId. n_{ID}^{IAS-RS}∈{0, 1, . . . , 1023} or n_{ID}^{IAS-RS}∈{0, 1, . . . , 65535}. The quantity l′∈{0, 1, . . . , N_{symb}^{IAS-RS}−1} is an OFDM symbol number within an IAS-RS resource.

If groupOrSequenceHopping is not hopping (neither), that is, neither group hopping nor sequence hopping is supported, f_{gh}(n_{s,f}^{μ}, l′)=0 v=0.

If groupOrSequenceHopping is group hopping (groupHopping), that is, group hopping is supported, but sequence hopping is not supported,

$$\begin{matrix}{f}_{g h} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 \\ v = 0\end{matrix} .$$

A pseudo-random sequence c(i) is generated by being initialized with cᵢₙᵢₜ=n_{ID}^{IAS-RS}.

If groupOrSequenceHopping is sequence hopping (sequenceHopping), that is, sequence hopping is supported, but group hopping is not supported,

$$\begin{matrix}{f}_{g h} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{sc , b}^{S R S} \geq 6 {N}_{sc}^{RB} \\ 0 & otherwise\end{matrix} .\end{matrix}$$

A pseudo-random sequence c(i) is initialized with cᵢₙᵢₜ=n_{ID}^{SRS}.

Optionally, the first configuration information is associated with a first identifier of a synchronization signal block, and/or the second configuration information is associated with a second identifier of the synchronization signal block.

Optionally, the first communication apparatus and/or the second communication apparatus may determine the first configuration information based on the first identifier of the synchronization signal block.

Optionally, the first communication apparatus and/or the second communication apparatus may determine the second configuration information based on the second identifier of the synchronization signal block.

In an embodiment in which the first communication procedure is contention-based initial access, first configuration information of a first signal (also referred to as an initial access parameter of the first signal) may include the parameters described above (such as the first subcarrier spacing, the first CP length, the first sequence length, the first time-domain length, the first quantity of symbols, the first time-domain resource, the first frequency-domain resource, or the first quantity of combs), a frequency-domain occasion, a time-domain occasion, information associated with generation of a signal sequence of the first signal, and the like. In the following, the parameters of the first signal, the frequency-domain occasion, the time-domain occasion, and the information associated with generation of the signal sequence of the first signal may also be collectively referred to as a “random access occasion” of the first signal.

In some implementations, there may be a first mapping relationship between the initial access parameter of the first signal and an SSB identifier. The first mapping relationship may be one-to-one, one-to-many, or many-to-one. For example, one SSB identifier corresponds to one initial access parameter of a first signal, one SSB identifier corresponds to a plurality of initial access parameters of first signals, or a plurality of SSB identifiers correspond to one initial access parameter of a first signal. The initial access parameter is determined in this manner so that signaling overheads can be reduced.

In some implementations, the SSB identifier may be used to identify an SSB beam. For example, SSB beams 1 to Q are mapped to RB numbers 1 to M1 or occasions 1 to M1, SSB beams 1 to Q are mapped to time-domain occasions 1 to M2, or SSB beams 1 to Q are mapped to sequences 1 to M3.

Specifically, for example, there is a first correspondence between the SSB identifier and the quantity of combs of the first signal. The first communication apparatus 110 determines the quantity of combs of the first signal based on a received SSB identifier, and sends the first signal to perform random access. The first correspondence may be at least one row in Table 3 to Table 5.

TABLE 3
One-to-one correspondences

| SSB identifier | Quantity of combs of a first signal |
|---|---|
| SSB identifier x1 | Comb = 1 |
| SSB identifier x2 | Comb = 2 |
| . . . | . . . |
| SSB identifier Q | Comb = C1 |

TABLE 4
One-to-many correspondences

| SSB identifier | Quantity of combs of a first signal |
|---|---|
| SSB identifier x1 | Comb = 1, 3 |
| SSB identifier x2 | Comb = 2, 4 |
| . . . | . . . |
| SSB identifier Q | Comb = C1, C2 |

TABLE 5
Many-to-one correspondences

| SSB identifier | Quantity of combs of a first signal |
|---|---|
| SSB identifiers x11 and x12 | Comb = 1 |
| SSB identifiers x21 and x22 | Comb = 2 |
| . . . | . . . |
| SSB identifiers q1 and q2 | Comb = C3 |

Specifically, for example, there is a second correspondence between the SSB identifier and the frequency-domain occasion of the first signal. The first communication apparatus 110 determines the frequency-domain occasion of the first signal based on a received SSB identifier, and sends the first signal to perform random access. The second correspondence may be at least one row in Table 6 to Table 8.

TABLE 6
One-to-one correspondences

| SSB identifier | Frequency-domain occasion of a first signal |
|---|---|
| SSB identifier x1 | Frequency-domain occasion 1 |
| SSB identifier x2 | Frequency-domain occasion 2 |
| . . . | . . . |
| SSB identifier Q | Frequency-domain occasion F1 |

TABLE 7
One-to-many correspondences

| SSB identifier | Frequency-domain occasion of a first signal |
|---|---|
| SSB identifier x1 | Frequency-domain occasions 1 and 2 |
| SSB identifier x2 | Frequency-domain occasions 3 and 4 |
| . . . | . . . |
| SSB identifier Q | Frequency-domain occasions F11 and F12 |

TABLE 8
Many-to-one correspondences

| SSB identifier | Frequency-domain occasion of a first signal |
|---|---|
| SSB identifiers x11 and x12 | Frequency-domain occasion 1 |
| SSB identifiers x21 and x22 | Frequency-domain occasion 2 |
| . . . | . . . |
| SSB identifiers q1 and q2 | Frequency-domain occasion F3 |

Specifically, for example, there is a third correspondence between the SSB identifier and the time-domain occasion of the first signal. The first communication apparatus 110 determines the time-domain occasion of the first signal based on a received SSB identifier, and sends the first signal to perform random access. The third correspondence may be at least one row in Table 9 to Table 11.

TABLE 9
One-to-one correspondences

| SSB identifier | Time-domain occasion of a first signal |
|---|---|
| SSB identifier x1 | Time-domain occasion 1 |
| SSB identifier x2 | Time-domain occasion 2 |
| . . . | . . . |
| SSB identifier Q | Time-domain occasion T1 |

TABLE 10
One-to-many correspondences

| SSB identifier | Time-domain occasion of a first signal |
|---|---|
| SSB identifier x1 | Time-domain occasions 1 and 2 |
| SSB identifier x2 | Time-domain occasions 3 and 4 |
| . . . | . . . |
| SSB identifier Q | Time-domain occasions T11 and T12 |

TABLE 11
Many-to-one correspondences

| SSB identifier | Time-domain occasion of a first signal |
|---|---|
| SSB identifiers x11 and x12 | Time-domain occasion 1 |
| SSB identifiers x21 and x22 | Time-domain occasion 2 |
| . . . | . . . |
| SSB identifiers q1 and q2 | Time-domain occasion T3 |

Specifically, for example, there is a fourth correspondence between the SSB identifier and the signal sequence of the first signal. The first communication apparatus 110 determines the signal sequence of the first signal based on a received SSB identifier, and sends the first signal to perform random access. The fourth correspondence may be at least one row in Table 12 to Table 14.

TABLE 12
One-to-one correspondences

| SSB identifier | Signal sequence of a first signal |
|---|---|
| SSB identifier x1 | Sequence 1 |
| SSB identifier x2 | Sequence 2 |
| . . . | . . . |
| SSB identifier Q | Sequence S1 |

TABLE 13
One-to-many correspondences

| SSB identifier | Signal sequence of a first signal |
|---|---|
| SSB identifier x1 | Sequences 1 and 2 |
| SSB identifier x2 | Sequences 3 and 4 |
| . . . | . . . |
| SSB identifier Q | Sequences S11 and S12 |

TABLE 14
Many-to-one correspondences

| SSB identifier | Signal sequence of a first signal |
|---|---|
| SSB identifiers x11 and x12 | Sequence 1 |
| SSB identifiers x21 and x22 | Sequence 2 |
| . . . | . . . |
| SSB identifiers q1 and q2 | Sequence S3 |

Specifically, for example, there is a fifth correspondence between the SSB identifier and the random access occasion of the first signal. The first communication apparatus 110 determines the random access occasion of the first signal based on a received SSB identifier, and sends the first signal to perform random access. The fifth correspondence may be at least one row in Table 15 to Table 17.

One random access occasion may correspond to one frequency-domain occasion, one time-domain occasion, and one sequence. That is, the first communication apparatus 110 may determine the frequency-domain resource, the time-domain resource, the signal sequence, and the like of the first signal by determining the random access occasion.

TABLE 15
One-to-one correspondences

| SSB identifier | Random access occasion of a first signal |
|---|---|
| SSB identifier x1 | Random access occasion 1 |
| SSB identifier x2 | Random access occasion 2 |
| . . . | . . . |
| SSB identifier Q | Random access occasion U1 |

TABLE 16
One-to-many correspondences

| SSB identifier | Random access occasion of a first signal |
|---|---|
| SSB identifier x1 | Random access occasions 1 and 2 |
| SSB identifier x2 | Random access occasions 3 and 4 |
| . . . | . . . |
| SSB identifier Q | Random access occasions U11 and U12 |

TABLE 17
Many-to-one correspondences

| SSB identifier | Random access occasion of a first signal |
|---|---|
| SSB identifiers x11 and x12 | Random access occasion 1 |
| SSB identifiers x21 and x22 | Random access occasion 2 |
| . . . | . . . |
| SSB identifiers q1 and q2 | Random access occasion U3 |

Optionally, the first configuration information is associated with a first resource identifier of a channel state information reference signal, and/or the second configuration information is associated with a second resource identifier of the channel state information reference signal.

Optionally, the first communication apparatus and/or the second communication apparatus may determine the first configuration information based on the first resource identifier of the channel state information reference signal.

Optionally, the first communication apparatus and/or the second communication apparatus may determine the second configuration information based on the second resource identifier of the channel state information reference signal.

In some implementations, the first configuration information of the first signal may be associated with a first identifier of the channel state information reference signal (CSI-RS). In the embodiment in which the first communication procedure is contention-based initial access, there may be a second mapping relationship between the initial access parameter of the first signal and a CSI-RS resource identifier. The second mapping relationship may be one-to-one, one-to-many, or many-to-one. For example, one CSI-RS resource identifier corresponds to one initial access parameter of a first signal, one CSI-RS resource identifier corresponds to a plurality of initial access parameters of first signals, or a plurality of CSI-RS resource identifiers correspond to one initial access parameter of a first signal. For example, CSI-RS resource identifiers 1 to W are mapped to RB numbers 1 to M1 or occasions 1 to M1, CSI-RS resource identifiers 1 to W are mapped to time-domain occasions 1 to M2, or CSI-RS resource identifiers 1 to W are mapped to sequences 1 to M3. The initial access parameter is determined in this manner so that signaling overheads can be reduced.

Specifically, for example, there is a sixth correspondence between the CSI-RS resource identifier and the quantity of combs of the first signal. The first communication apparatus 110 determines the quantity of combs of the first signal based on a received CSI-RS resource identifier, and sends the first signal to perform random access. The sixth correspondence may be at least one row in Table 18 to Table 20.

TABLE 18
One-to-one correspondences

| CSI-RS resource identifier | Quantity of combs of a first signal |
|---|---|
| CSI-RS resource identifier y1 | Comb = 1 |
| CSI-RS resource identifier y2 | Comb = 2 |
| . . . | . . . |
| CSI-RS resource identifier J | Comb = C1 |

TABLE 19
One-to-many correspondences

| CSI-RS resource identifier | Quantity of combs of a first signal |
|---|---|
| CSI-RS resource identifier y1 | Comb = 1, 3 |
| CSI-RS resource identifier y2 | Comb = 2, 4 |
| . . . | . . . |
| CSI-RS resource identifier J | Comb = C1, C2 |

TABLE 20
Many-to-one correspondences

| | Quantity of combs of a first |
|---|---|
| CSI-RS resource identifier | signal |
| CSI-RS resource identifiers y11 and y12 | Comb = 1 |
| CSI-RS resource identifiers y21 and y22 | Comb = 2 |
| . . . | . . . |
| CSI-RS resource identifiers J1 and J2 | Comb = C3 |

Specifically, for example, there is a seventh correspondence between the CSI-RS resource identifier and the frequency-domain occasion of the first signal. The first communication apparatus 110 determines the frequency-domain occasion of the first signal based on a received CSI-RS resource identifier, and sends the first signal to perform random access. The seventh correspondence may be at least one row in Table 21 to Table 23.

TABLE 21
One-to-one correspondences

| | Frequency-domain occasion |
|---|---|
| CSI-RS resource identifier | of a first signal |
| CSI-RS resource identifier y1 | Frequency-domain occasion 1 |
| CSI-RS resource identifier y2 | Frequency-domain occasion 2 |
| . . . | . . . |
| CSI-RS resource identifier J | Frequency-domain occasion F1 |

TABLE 22
One-to-many correspondences

| | Frequency-domain occasion |
|---|---|
| CSI-RS resource identifier | of a first signal |
| CSI-RS resource identifier y1 | Frequency-domain occasions 1 and 2 |
| CSI-RS resource identifier y2 | Frequency-domain occasions 3 and 4 |
| . . . | . . . |
| CSI-RS resource identifier J | Frequency-domain occasions F11 and F12 |

TABLE 23
Many-to-one correspondences

| | Frequency-domain occasion |
|---|---|
| CSI-RS resource identifier | of a first signal |
| CSI-RS resource identifiers y11 and y12 | Frequency-domain occasion 1 |
| CSI-RS resource identifiers y21 and y22 | Frequency-domain occasion 2 |
| . . . | . . . |
| CSI-RS resource identifiers J1 and J2 | Frequency-domain occasion F3 |

Specifically, for example, there is an eighth correspondence between the CSI-RS resource identifier and the time-domain occasion of the first signal. The first communication apparatus 110 determines the time-domain occasion of the first signal based on a received CSI-RS resource identifier, and sends the first signal to perform random access. The eighth correspondence may be at least one row in Table 24 to Table 26.

TABLE 24
One-to-one correspondences

| CSI-RS resource identifier | Time-domain occasion of a first signal |
|---|---|
| CSI-RS resource identifier y1 | Time-domain occasion 1 |
| CSI-RS resource identifier y2 | Time-domain occasion 2 |
| . . . | . . . |
| CSI-RS resource identifier J | Time-domain occasion T1 |

TABLE 25
One-to-many correspondences

| CSI-RS resource identifier | Time-domain occasion of a first signal |
|---|---|
| CSI-RS resource identifier y1 | Time-domain occasions 1 and 2 |
| CSI-RS resource identifier y2 | Time-domain occasions 3 and 4 |
| . . . | . . . |
| CSI-RS resource identifier J | Time-domain occasions T11 and T12 |

TABLE 26
Many-to-one correspondences

| | Time-domain occasion of a |
|---|---|
| CSI-RS resource identifier | first signal |
| CSI-RS resource identifiers y11 and y12 | Time-domain occasion 1 |
| CSI-RS resource identifiers y21 and y22 | Time-domain occasion 2 |
| . . . | . . . |
| CSI-RS resource identifiers J1 and J2 | Time-domain occasion T3 |

Specifically, for example, there is a ninth correspondence between the CSI-RS resource identifier and the signal sequence of the first signal. The first communication apparatus 110 determines the signal sequence of the first signal based on a received CSI-RS resource identifier, and sends the first signal to perform random access. The ninth correspondence may be at least one row in Table 27 to Table 29.

TABLE 27
One-to-one correspondences

| CSI-RS resource identifier | Signal sequence of a first signal |
|---|---|
| CSI-RS resource identifier y1 | Sequence 1 |
| CSI-RS resource identifier y2 | Sequence 2 |
| . . . | . . . |
| CSI-RS resource identifier J | Sequence S1 |

TABLE 28
One-to-many correspondences

| CSI-RS resource identifier | Signal sequence of a first signal |
|---|---|
| CSI-RS resource identifier y1 | Sequences 1 and 2 |
| CSI-RS resource identifier y2 | Sequences 3 and 4 |
| . . . | . . . |
| CSI-RS resource identifier J | Sequences S11 and S12 |

TABLE 29
Many-to-one correspondences

| CSI-RS resource identifier | Signal sequence of a first signal |
|---|---|
| CSI-RS resource identifiers y11 and y12 | Sequence 1 |
| CSI-RS resource identifiers y21 and y22 | Sequence 2 |
| . . . | . . . |
| CSI-RS resource identifiers J1 and J2 | Sequence F3 |

Specifically, for example, there is a tenth correspondence between the CSI-RS resource identifier and the random access occasion of the first signal. The first communication apparatus 110 determines the random access occasion of the first signal based on a received CSI-RS resource identifier, and sends the first signal to perform random access. The tenth correspondence may be at least one row in Table 30 to Table 32.

One random access occasion may correspond to one frequency-domain occasion, one time-domain occasion, and one sequence. That is, the first communication apparatus 110 may determine the frequency-domain resource, the time-domain resource, the signal sequence, and the like of the first signal by determining the random access occasion.

TABLE 30
One-to-one correspondences

| CSI-RS resource identifier | Random access occasion of a first signal |
|---|---|
| CSI-RS resource identifier y1 | Random access occasion 1 |
| CSI-RS resource identifier y2 | Random access occasion 2 |
| . . . | . . . |
| CSI-RS resource identifier J | Random access occasion U1 |

TABLE 31
One-to-many correspondences

| CSI-RS resource identifier | Random access occasion of a first signal |
|---|---|
| CSI-RS resource identifier y1 | Random access occasions 1 and 2 |
| CSI-RS resource identifier y2 | Random access occasions 3 and 4 |
| . . . | . . . |
| CSI-RS resource identifier J | Random access occasions U11 and U12 |

TABLE 32
Many-to-one correspondences

| | Random access occasion of |
|---|---|
| CSI-RS resource identifier | a first signal |
| CSI-RS resource identifiers y11 and y12 | Random access occasion 1 |
| CSI-RS resource identifiers y21 and y22 | Random access occasion 2 |
| . . . | . . . |
| CSI-RS resource identifiers J1 and J2 | Random access occasion U3 |

A specific correspondence to be used in the foregoing correspondences may be predefined, or may be notified by the second communication apparatus 120 to the first communication apparatus 110 through signaling. The scope of this disclosure is not limited in this aspect.

According to the foregoing embodiments, a correspondence between the first signal and the SSB and/or the CSI-RS is defined so that signaling overheads can be reduced, UE can quickly perform random access, and a latency can be reduced. As a result, resource sharing for random access and channel measurement is implemented, resource utilization is improved, and communication efficiency is improved.

As described above, the first communication apparatus 110 may send the first signal based on the first configuration information, for initial access. In some implementations, the initial access may be contention-free initial access. The following provides a detailed description with reference to FIG. 7.

FIG. 7 is a signaling interaction diagram of a communication method 700 according to some embodiments of this disclosure. For ease of discussion, the method 700 is discussed with reference to the communication system 100 in FIG. 1. The method 700 relates to the first communication apparatus 110 and the second communication apparatus 120 in FIG. 1. The method 700 may be understood as another example implementation of the method 200. However, it should be understood that the method 700 may also be performed between communication apparatuses in any other communication scenario.

As shown in FIG. 7, the second communication apparatus 120 sends (710) first configuration information of a first signal to the first communication apparatus 110. Correspondingly, the first communication apparatus 110 receives (715) the first configuration information of the first signal from the second communication apparatus 120. Next, the first communication apparatus 110 sends (720) the first signal to the second communication apparatus 120 based on the first configuration information. Correspondingly, the second communication apparatus 120 receives (725) the first signal from the first communication apparatus 110. Then, the second communication apparatus 120 sends (730) a random access response to the first communication apparatus 110. Correspondingly, the first communication apparatus 110 receives (735) the random access response from the second communication apparatus 120.

In some implementations, the second communication apparatus 120 may configure, by using higher layer signaling (for example, dedicated RRC signaling), the first configuration information to indicate a contention-free initial access parameter, or may indicate a contention-free initial access parameter by using DCI triggered by physical layer signaling (for example, PDCCH-order).

In some implementations, the second communication apparatus 120 may be separately configured with at least one of the following three types of information (specific parameters are described in the foregoing embodiments, and details are not described herein again):
(1) a frequency-domain occasion
   a quantity of RBs included in each frequency-domain occasion
   an occasion number (a quantity of occasions or an occasion index)
   a total quantity of RBs
   a total quantity of frequency-domain occasions
(2) a time-domain occasion
   a time-domain starting symbol
   a quantity of occasions in each slot
   a slot number in each subframe
   a subframe number
(3) a sequence
   a sequence group number
   a sequence number
   a sequence identity of the first signal
   a cyclic shift

In some other embodiments, the second communication apparatus 120 may jointly indicate the information. For example, the second communication apparatus 120 may indicate that random access numbers are 1 to Md, and one number corresponds to one frequency-domain occasion, one time-domain occasion, and one signal sequence. The correspondence may be predefined, or may be configured by the second communication apparatus 120 for the first communication apparatus 110.

In some implementations, the first communication apparatus 110 may receive a plurality of first configuration information sets of the first signal from the second communication apparatus 120, and obtain the first configuration information from the plurality of first configuration information sets. For example, the first communication apparatus 110 may receive, from the second communication apparatus 120, a plurality of first configuration information sets shown in Table 33. The first configuration information set may include one or more rows in the table, and/or may include one or more columns in the table.

TABLE 33

| First configuration | | Subcarrier | Quantity |
|---|---|---|---|
| information set | CP length | spacing | of symbols |
| A1 | T11 (2 μs) | u11 = 60 kHz | n11 = 2 |
| B1 | T21 (3 μs) | u21 = 45 kHz | n21 = 2 |
| C1 | T31 (4 μs) | u31 = 30 kHz | n31 = 1 |

As shown in Table 33, the first communication apparatus 110 may receive first configuration information sets A1, B1, and C1 from the second communication apparatus 120. Then, the first communication apparatus 110 may obtain the first configuration information from the first configuration information sets A1, B1, and C1. For example, the first communication apparatus 110 may select one of the first configuration information sets A1, B1, and C1 as the first configuration information.

In some implementations, the first communication apparatus 110 may receive a plurality of second configuration information sets of the first signal from the second communication apparatus 120, and obtain the second configuration information from the plurality of second configuration information sets. For example, the first communication apparatus 110 may receive, from the second communication apparatus 120, a plurality of second configuration information sets shown in Table 34. The second configuration information set may include one or more rows in the table, and/or may include one or more columns in the table.

TABLE 34

| Second configuration | CP | Subcarrier | Quantity |
|---|---|---|---|
| information set | length | spacing | of symbols |
| A2 | T12 | u12 | n12 |
| B2 | T22 | u22 | n22 |
| C2 | T32 | u32 | n32 |

As shown in Table 34, the first communication apparatus 110 may receive second configuration information sets A2, B2, and C2 from the second communication apparatus 120. Then, the first communication apparatus 110 may obtain the second configuration information from the second configuration information sets A2, B2, and C2. For example, the first communication apparatus 110 may select one of the second configuration information sets A2, B2, and C2 as the second configuration information.

In some implementations, the first communication apparatus 110 may obtain the first configuration information from the plurality of first configuration information sets based on at least one of the following: a type of the first communication apparatus 110, a capability of the first communication apparatus 110, a position of the first communication apparatus 110, or a moving speed of the first communication apparatus 110. The first configuration information of the first signal is obtained in this manner so that signaling overheads can be reduced. In addition, different first configuration information may be configured for different first communication apparatuses or different capabilities, positions, moving speeds, types, and the like of the first communication apparatus, to meet requirements of different users and to improve communication efficiency and performance.

In some implementations, the first communication apparatus 110 may obtain the first configuration information from the plurality of first configuration information sets based on a first communication procedure and the type of the first communication apparatus 110. The first configuration information of the first signal is obtained in this manner so that signaling overheads can be reduced. In addition, different first configuration information may be configured for different types of the first communication apparatus, different communication procedures, and the like, to meet requirements of different users and to improve communication efficiency and performance.

Similarly, in some implementations, the first communication apparatus 110 may obtain the second configuration information from the plurality of second configuration information sets based on at least one of the following: the type of the first communication apparatus 110, the capability of the first communication apparatus 110, the position of the first communication apparatus 110, or the moving speed of the first communication apparatus 110. In some implementations, the first communication apparatus 110 may obtain the second configuration information from the plurality of second configuration information sets based on a second communication procedure and the type of the first communication apparatus 110. The second configuration information of the first signal is obtained in this manner so that signaling overheads can be reduced. In addition, different second configuration information may be configured for different first communication apparatuses or different capabilities, positions, moving speeds, types, and the like of the first communication apparatus, to meet requirements of different users and to improve communication efficiency and performance.

Optionally, a capability of a communication apparatus may be an antenna capability, a decoding capability, a complexity capability, a data receiving processing capability, a data sending processing capability, a receiver capability, a transmitter capability, or the like of the communication apparatus.

For example, the antenna capability may refer to a largest receive antenna, a largest transmit antenna, or the like, and the decoding capability may refer to whether an advanced receiver is supported. The complexity capability may refer to a status of complexity supported by the communication apparatus, for example, whether processing for machine learning, artificial intelligence, a neural network, or the like is supported. The data receiving processing capability may refer to a physical downlink shared channel (PDSCH) processing capability, for example, a PDSCH processing capability 1 or a PDSCH processing capability 2. The data sending processing capability may refer to a physical uplink shared channel (PUSCH) processing capability, for example, a PUSCH processing capability 1 or a PUSCH processing capability 2. The receiver capability may refer to whether a complex receiver is supported, for example, a receiver that can perform iterative decoding and interference cancellation, and the like, is supported. The transmitter capability may refer to whether multi-point sending or the like is supported.

Optionally, a position of the communication apparatus may be within a physical area or a physical range, in a blocked environment, inside a building, outside a building, in an urban area, in a suburban area, or the like, or may refer to a distance between the communication apparatus and a transmit end, a distance between the communication apparatus and a receive end.

Optionally, a moving speed of the communication apparatus may be 10 km/h, 50 km/h, 200 km/h, or the like.

Optionally, the communication apparatus may have at least one of the following types: an eMBB terminal, a URLLC terminal, an IoT terminal, CPE, a V2X terminal, or the like.

Optionally, the type of the communication apparatus may alternatively be determined based on the capability, the position, the moving speed, or another parameter of the communication apparatus.

As an example, the first communication apparatus 110 may receive, from the second communication apparatus 120, a plurality of first configuration information sets and a plurality of second configuration information sets that are shown in Table 35. The first configuration information set and the second configuration information set may include one or more rows in the table, and/or may include one or more columns in the table.

TABLE 35

| Type of a first | Configuration | | | |
|---|---|---|---|---|
| communication | information | CP | Subcarrier | Quantity |
| apparatus 110 | set | length | spacing | of symbols |
| A | A1 | T11 | u11 | n11 |
| | A2 | T12 | u12 | n12 |
| | A3 | T13 | u13 | n13 |
| B | B1 | T21 | u21 | n21 |
| | B2 | T22 | u22 | n22 |
| | B3 | T23 | u23 | n23 |
| C | C1 | T31 | u31 | n31 |
| | C2 | T32 | u32 | n32 |
| | C3 | T33 | u33 | n33 |

As shown in Table 35, the first communication apparatus 110 may receive, from the second communication apparatus 120, first configuration information sets A1, B1, and C1 used for initial access and second configuration information sets A2, B2, and C2 used for uplink synchronization.

Optionally, the first communication apparatus may determine the first configuration information from the plurality of first configuration information sets based on the type of the first communication apparatus and the first communication procedure.

If the first communication apparatus 110 determines that the type of the first communication apparatus 110 is A and the first communication procedure is initial access, the first communication apparatus 110 may select the configuration information set A1 as the first configuration information.

Optionally, the first communication apparatus may determine the second configuration information from the plurality of second configuration information sets based on the type of the first communication apparatus and the second communication procedure.

If the first communication apparatus 110 determines that the type of the first communication apparatus 110 is B and the second communication procedure is uplink synchronization, the first communication apparatus 110 may select the configuration information set B2 as the second configuration information.

As another example, the first communication apparatus 110 may receive, from the second communication apparatus 120, a plurality of first configuration information sets and a plurality of second configuration information sets that are shown in Table 36. The first configuration information set and the second configuration information set may include one or more rows in the table, and/or may include one or more columns in the table.

TABLE 36

| Capability of a first | Configuration | | | |
|---|---|---|---|---|
| communication | information | CP | Subcarrier | Quantity |
| apparatus 110 | set | length | spacing | of symbols |
| First capability | A1 | T11 | u11 | n11 |
| | A2 | T12 | u12 | n12 |
| | A3 | T13 | u13 | n13 |
| Second capability | B1 | T21 | u21 | n21 |
| | B2 | T22 | u22 | n22 |
| | B3 | T23 | u23 | n23 |
| Third capability | C1 | T31 | u31 | n31 |
| | C2 | T32 | u32 | n32 |
| | C3 | T33 | u33 | n33 |

As shown in Table 36, the first communication apparatus 110 may receive, from the second communication apparatus 120, first configuration information sets A1, B1, and C1 used for initial access and second configuration information sets A2, B2, and C2 used for uplink synchronization.

Optionally, the first communication apparatus may determine the first configuration information from the plurality of first configuration information sets based on the capability of the first communication apparatus and the first communication procedure.

If the first communication apparatus 110 determines that the capability of the first communication apparatus 110 is the first capability and the first communication procedure is initial access, the first communication apparatus 110 may select the configuration information set A1 as the first configuration information.

Optionally, the first communication apparatus may determine the second configuration information from the plurality of second configuration information sets based on the capability of the first communication apparatus and the second communication procedure.

If the first communication apparatus 110 determines that the capability of the first communication apparatus 110 is the second capability and the second communication procedure is uplink synchronization, the first communication apparatus 110 may select the configuration information set B2 as the second configuration information.

It should be understood that the first capability, the second capability, and the third capability that are shown in Table 36 each may be any one of the foregoing capabilities of the communication apparatus.

As still another example, the first communication apparatus 110 may receive, from the second communication apparatus 120, a plurality of first configuration information sets and a plurality of second configuration information sets that are shown in Table 37. The first configuration information set and the second configuration information set may include one or more rows in the table, and/or may include one or more columns in the table.

TABLE 37

| Capability of a first | Configuration | | | |
|---|---|---|---|---|
| communication | information | CP | Subcarrier | Quantity |
| apparatus 110 | set | length | spacing | of symbols |
| First moving speed | A1 | T11 | u11 | n11 |
| | A2 | T12 | u12 | n12 |
| | A3 | T13 | u13 | n13 |
| Second moving | B1 | T21 | u21 | n21 |
| speed | B2 | T22 | u22 | n22 |
| | B3 | T23 | u23 | n23 |
| Third moving | C1 | T31 | u31 | n31 |
| speed | C2 | T32 | u32 | n32 |
| | C3 | T33 | u33 | n33 |

As shown in Table 37, the first communication apparatus 110 may receive, from the second communication apparatus 120, first configuration information sets A1, B1, and C1 used for initial access and second configuration information sets A2, B2, and C2 used for uplink synchronization.

Optionally, the first communication apparatus may determine the first configuration information from the plurality of first configuration information sets based on the moving speed of the first communication apparatus and the first communication procedure.

If the first communication apparatus 110 determines that the moving speed of the first communication apparatus 110 is the first moving speed and the first communication procedure is initial access, the first communication apparatus 110 may select the configuration information set A1 as the first configuration information.

Optionally, the first communication apparatus may determine the second configuration information from the plurality of second configuration information sets based on the moving speed of the first communication apparatus and the second communication procedure.

If the first communication apparatus 110 determines that the type of the first communication apparatus 110 is the second moving speed and the second communication procedure is uplink synchronization, the first communication apparatus 110 may select the configuration information set B2 as the second configuration information.

It should be understood that the first moving speed, the second moving speed, and the third moving speed that are shown in Table 37 each may be any one of the foregoing moving speeds of the communication apparatus.

As yet another example, the first communication apparatus 110 may receive, from the second communication apparatus 120, a plurality of first configuration information sets and a plurality of second configuration information sets that are shown in Table 38. The first configuration information set and the second configuration set may include one or more rows in the table, and/or the configuration information may indicate one or more of a CP length, a subcarrier spacing, and a quantity of symbols. Information that is not indicated by the configuration information may be predefined in a protocol, or may be configured by the second communication apparatus 120 by using configuration information other than the first configuration information set and the second configuration information set.

TABLE 38

| Capability of a first | Configuration | | | |
|---|---|---|---|---|
| communication | information | CP | Subcarrier | Quantity |
| apparatus 110 | set | length | spacing | of symbols |
| First position | A1 | T11 | u11 | n11 |
| | A2 | T12 | u12 | n12 |
| | A3 | T13 | u13 | n13 |
| Second position | B1 | T21 | u21 | n21 |
| | B2 | T22 | u22 | n22 |
| | B3 | T23 | u23 | n23 |
| Third position | C1 | T31 | u31 | n31 |
| | C2 | T32 | u32 | n32 |
| | C3 | T33 | u33 | n33 |

As shown in Table 38, the first communication apparatus 110 may receive, from the second communication apparatus 120, first configuration information sets A1, B1, and C1 used for initial access and second configuration information sets A2, B2, and C₂ used for uplink synchronization.

Optionally, the first communication apparatus may determine the first configuration information from the plurality of first configuration information sets based on the position of the first communication apparatus and the first communication procedure.

If the first communication apparatus 110 determines that the position of the first communication apparatus 110 is the first position and the first communication procedure is initial access, the first communication apparatus 110 may select the configuration information set A1 as the first configuration information.

Optionally, the first communication apparatus may determine the second configuration information from the plurality of second configuration information sets based on the position of the first communication apparatus and the second communication procedure.

If the first communication apparatus 110 determines that the position of the first communication apparatus 110 is the second position and the second communication procedure is uplink synchronization, the first communication apparatus 110 may select the configuration information set B2 as the second configuration information.

It should be understood that the first position, the second position, and the third position that are shown in Table 38 each may be any one of the foregoing positions of the communication apparatus.

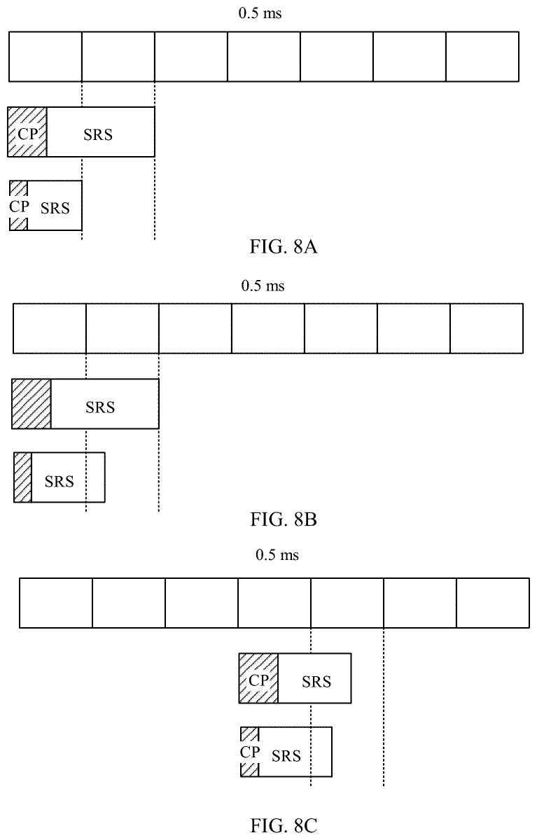

In some implementations, different functions, procedures, or mechanisms may correspond to different CP lengths and subcarrier spacings of the first signal. In such implementations, the first communication apparatus 110 may use a solution of symbol boundary alignment, for example, as shown in FIG. 8A. In such implementations, the first communication apparatus 110 may use a solution of symbol alignment based on a reference subcarrier spacing, for example, alignment with boundaries of a symbol of a signal with a subcarrier spacing of 15 kHz or 30 kHz. Alternatively, the first communication apparatus 110 may use a solution of symbol alignment based on a configured subcarrier spacing.

In such embodiments, the second communication apparatus 120 may configure at least one of the following information for the first communication apparatus 110:
a starting position: a starting symbol
a CP length, for example, one symbol, two symbols, x1 μs, or y1 Ts. Alternatively, the second communication apparatus 120 may perform joint configuration or difference configuration of the CP length. For example, as shown in Table 35 to Table 38, a CP length of an SRS used for initial access is T11, a CP length of an SRS used for uplink synchronization is T12, and a CP length of an SRS used for channel sounding is T13.
a quantity of symbols of a signal, for example, a quantity of symbols (joint configuration) that corresponds to a reference subcarrier spacing or a configured subcarrier spacing. For example, as shown in Table 5, a quantity of symbols of a signal used for initial access is n11, a quantity of symbols of a signal used for uplink synchronization is n12, and a quantity of symbols of a signal used for channel sounding is n13.

In some implementations, the first communication apparatus 110 may use a solution in which boundaries of symbols are not aligned, for example, as shown in FIG. 8B and FIG. 8C.

In such embodiments, the second communication apparatus 120 may configure at least one of the following information for the first communication apparatus 110:
a starting position: a starting symbol
a CP length, for example, one symbol, two symbols, x1 μs, or y1 Ts. Alternatively, the second communication apparatus 120 may perform joint configuration or difference configuration of the CP length. For example, as shown in Table 5, a CP length of a signal used for initial access is T21, a CP length of a signal used for uplink synchronization is T22, and a CP length of a signal used for channel sounding is T23. Joint configuration means that absolute values of a plurality of CP lengths for different communication procedures may be configured. Difference configuration means that a first CP length and a difference may be configured for the first communication procedure, and a CP length used for the second communication procedure may be determined based on the first CP length and the difference.
a symbol length of a signal, for example, a symbol length that corresponds to a subcarrier spacing or a quantity of symbols (joint configuration) that corresponds to a subcarrier spacing. For example, as shown in Table 5, a quantity of symbols of a signal used for initial access is n21, a quantity of symbols of a signal used for uplink synchronization is n22, and a quantity of symbols of a signal used for channel sounding is n23.

In this way, the first communication apparatus 110 can support first signals with a plurality of CP lengths, to implement functions of initial access, uplink synchronization, and channel sounding. Different functions or procedures may correspond to transmission of first signals with different CP lengths.

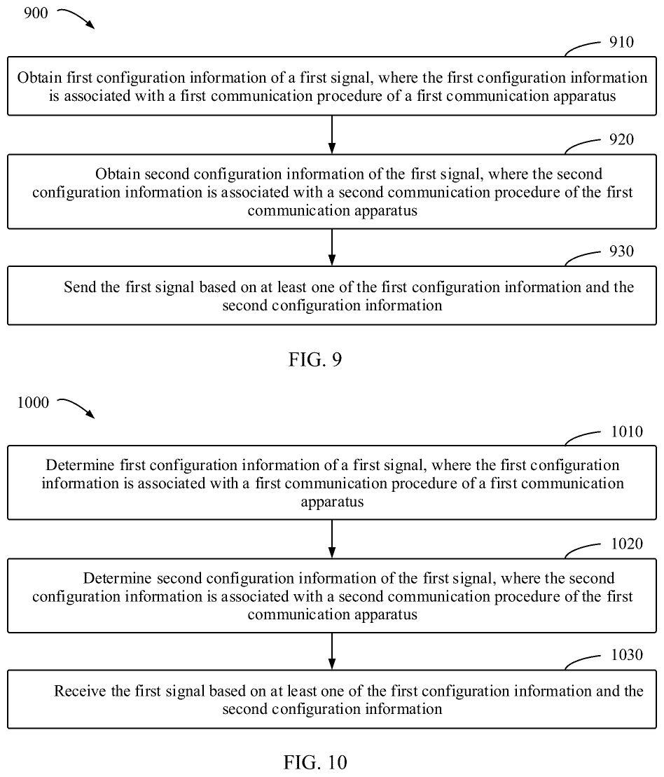

FIG. 9 is a flowchart of a communication method 900 according to some embodiments of this disclosure. In some implementations, the method 900 may be implemented by the first communication apparatus 110 in the example communication system 100, for example, may be implemented by a processor or a processing unit of the first communication apparatus 110 in cooperation with another component (for example, a transceiver). In another embodiment, the method 900 may also be implemented by another communication apparatus independent of the example communication system 100. For ease of description, the method 900 is described with reference to FIG. 1.
910: The first communication apparatus 110 obtains first configuration information of a first signal, where the first configuration information is associated with a first communication procedure of the first communication apparatus 110.
920: The first communication apparatus 110 obtains second configuration information of the first signal, where the second configuration information is associated with a second communication procedure of the first communication apparatus 110.
930: The first communication apparatus 110 sends the first signal based on at least one of the first configuration information or the second configuration information.

In this way, the first communication apparatus 110 can use a same type of signals for different communication procedures. This reduces processing complexity, and can further reduce chip costs of the first communication apparatus. In addition, a same signal can be used for different communication procedures so that resource utilization can be improved.

In some implementations, a sequence of 910 and 920 is not limited. 910 may be performed before 920, or 920 may be performed before 910, or 910 and 920 may be performed simultaneously.

In some implementations, that the first communication apparatus 110 obtains first configuration information of a first signal includes at least one of the following: the first communication apparatus 110 receives the first configuration information from the second communication apparatus 120; the first communication apparatus 110 receives a plurality of first configuration information sets of the first signal, and obtains the first configuration information from the plurality of first configuration information sets; or the first communication apparatus 110 obtains the first configuration information based on at least one of the following: a capability of the first communication apparatus 110, a position of the first communication apparatus 110, a moving speed of the first communication apparatus 110, or a type of the first communication apparatus 110.

In addition, different first configuration information may be configured for different communication apparatuses or different capabilities, positions, moving speeds, types, and the like of a communication apparatus, to meet requirements of different users and to improve communication efficiency and performance.

In some implementations, that the first communication apparatus 110 obtains first configuration information of a first signal includes at least one of the following: the first communication apparatus 110 obtains a plurality of first configuration information sets of the first signal, and obtains the first configuration information from the plurality of first configuration information sets; or the first communication apparatus 110 obtains the first configuration information based on at least one of the following: a capability of the first communication apparatus 110, a position of the first communication apparatus 110, a moving speed of the first communication apparatus 110, or a type of the first communication apparatus 110. The first configuration information of the first signal is obtained in this manner so that signaling overheads can be reduced.

In some implementations, that the first communication apparatus 110 obtains a plurality of first configuration information sets of the first signal may be obtaining the plurality of first configuration information sets of the first signal from the second communication apparatus 120, or may be obtaining the plurality of first configuration information sets of the first signal from the third communication apparatus 130; or the plurality of first configuration information sets may be predefined in a protocol. The first configuration information of the first signal is obtained in this manner so that signaling overheads can be reduced.

In some implementations, obtaining the first configuration information based on the type of the first communication apparatus 110 includes: obtaining a plurality of first configuration information sets of the first signal; and obtaining the first configuration information from the plurality of first configuration information sets based on the first communication procedure and the type of the first communication apparatus 110. The first configuration information of the first signal is obtained in this manner so that signaling overheads can be reduced. In addition, different first configuration information may be configured for different types of communication apparatuses, different communication procedures, and the like, to meet requirements of different users and to improve communication efficiency and performance.

In some implementations, that the first communication apparatus 110 obtains second configuration information of the first signal includes at least one of the following: the first communication apparatus 110 receives the second configuration information from the second communication apparatus 120; the first communication apparatus 110 receives a plurality of second configuration information sets of the first signal, and obtains the second configuration information from the plurality of first configuration information sets; or the first communication apparatus 110 obtains the second configuration information based on at least one of the following: the capability of the first communication apparatus 110, the position of the first communication apparatus 110, the moving speed of the first communication apparatus 110, or the type of the first communication apparatus 110. The second configuration information of the first signal is obtained in this manner so that signaling overheads can be reduced. In addition, different second configuration information may be configured for different communication apparatuses, or different capabilities, positions, moving speeds, types, and the like of a communication apparatus, to meet requirements of different users and to improve communication efficiency and performance.

In some implementations, that the first communication apparatus 110 obtains second configuration information of the first signal includes at least one of the following: the first communication apparatus 110 obtains a plurality of second configuration information sets of the first signal, and obtains the second configuration information from the plurality of second configuration information sets; or the first communication apparatus 110 obtains the second configuration information based on at least one of the following: the capability of the first communication apparatus 110, the position of the first communication apparatus 110, the moving speed of the first communication apparatus 110, or the type of the first communication apparatus 110. The second configuration information of the first signal is obtained in this manner so that signaling overheads can be reduced.

In some implementations, that the first communication apparatus 110 obtains a plurality of second configuration information sets of the first signal may be obtaining the plurality of second configuration information sets of the first signal from the second communication apparatus 120, or may be obtaining the plurality of second configuration information sets of the first signal from the third communication apparatus 130; or the plurality of second configuration information sets may be predefined in a protocol. The second configuration information of the first signal is obtained in this manner so that signaling overheads can be reduced. In addition, different second configuration information may be configured for different types of communication apparatuses, different communication procedures, and the like, to meet requirements of different users and to improve communication efficiency and performance.

In some implementations, obtaining the second configuration information based on the type of the first communication apparatus 110 includes: obtaining a plurality of second configuration information sets of the first signal; and obtaining the second configuration information from the plurality of second configuration information sets based on the second communication procedure and the type of the first communication apparatus 110.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus 110 and the second communication apparatus 120; beam selection for communication between the first communication apparatus 110 and the second communication apparatus 120; or beam recovery for communication between the first communication apparatus 110 and the second communication apparatus 120.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence. The first configuration information and/or the second configuration information of the first signal are/is obtained in this manner so that flexible configuration of the foregoing parameters can be implemented. In addition, different parameter values may be configured for different types of terminal devices, different communication procedures, and the like, to meet requirements of different users and to improve communication efficiency and performance.

FIG. 10 is a flowchart of a communication method 1000 according to some embodiments of this disclosure. In some implementations, the method 1000 may be implemented by the second communication apparatus 120 in the example communication system 100, for example, may be implemented by a processor or a processing unit of the second communication apparatus 120 in cooperation with another component (for example, a transceiver). In another embodiment, the method 1000 may also be implemented by another communication apparatus independent of the example communication system 100. For ease of description, the method 1000 is described with reference to FIG. 1.
1010: The second communication apparatus 120 determines first configuration information of a first signal, where the first configuration information is associated with a first communication procedure of the first communication apparatus 110.
1020: The second communication apparatus 120 determines second configuration information of the first signal, where the second configuration information is associated with a second communication procedure of the first communication apparatus 110.
1030: The second communication apparatus 120 receives the first signal from the first communication apparatus 110 based on at least one of the first configuration information or the second configuration information.

In this way, a same signal can be used for different communication procedures so that resource utilization can be improved.

In some implementations, a sequence of 1010 and 1020 is not limited. 1010 may be performed before 1020, or 1020 may be performed before 1010, or 1010 and 1020 may be performed simultaneously.

In some implementations, the method 1000 further includes: sending the first configuration information or a plurality of first configuration information sets of the first signal to the first communication apparatus 110. The first configuration information of the first signal is sent in this manner so that signaling overheads can be reduced.

In some implementations, the method 1000 further includes: sending the second configuration information or a plurality of second configuration information sets of the first signal to the first communication apparatus 110. The second configuration information of the first signal is sent in this manner so that signaling overheads can be reduced.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus 110 and the second communication apparatus 120; beam selection for communication between the first communication apparatus 110 and the second communication apparatus 120; or beam recovery for communication between the first communication apparatus 110 and the second communication apparatus 120.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; and information associated with generation of the signal sequence. The first configuration information and/or the second configuration information of the first signal are/is sent in this manner so that flexible configuration of the foregoing parameters can be implemented. In addition, different parameter values may be configured for different types of communication apparatuses, different communication procedures, and the like, to meet requirements of different users and to improve communication efficiency and performance.

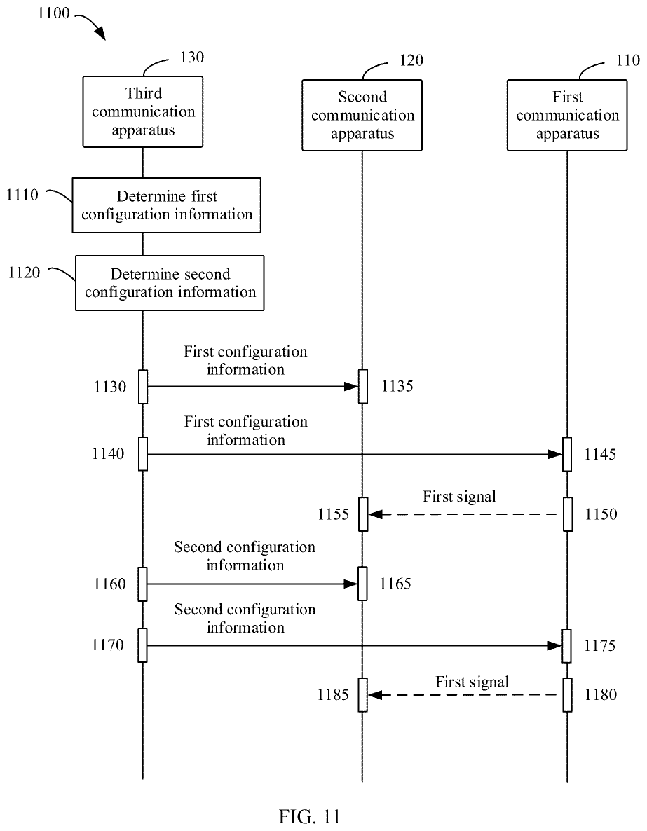

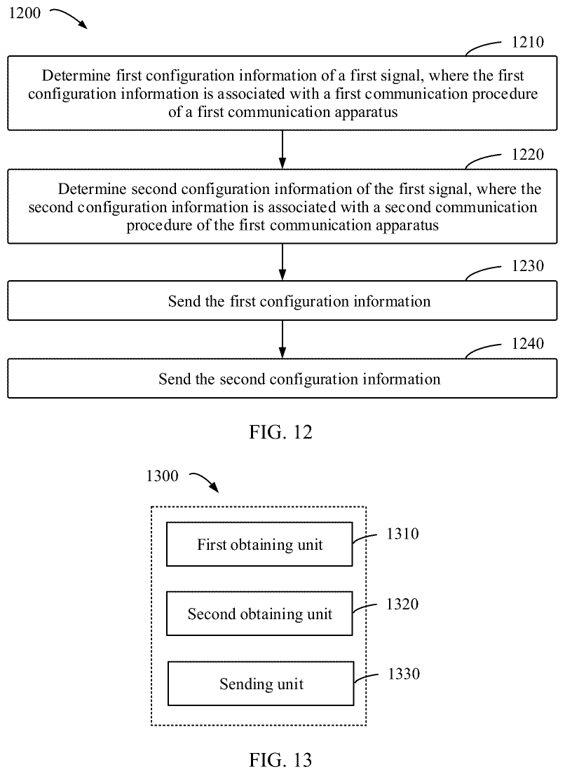

The foregoing describes an embodiment in which the second communication apparatus 120 may send the first configuration information and the second configuration information. In some implementations, the third communication apparatus 130 may send the first configuration information and the second configuration information, for a communication procedure between the first communication apparatus 110 and the second communication apparatus 120. The following provides a detailed description with reference to FIG. 11 and FIG. 12.

FIG. 11 is a signaling interaction diagram of a communication process 1100 according to some embodiments of this disclosure. For ease of discussion, the process 1100 is discussed with reference to the communication system 100 in FIG. 1. The process 1100 relates to the first communication apparatus 110, the second communication apparatus 120, and the third communication apparatus 130 in FIG. 1. However, it should be understood that the process 1100 may also be performed between communication apparatuses in any other communication scenario.

As shown in FIG. 11, the third communication apparatus 130 determines (1110) first configuration information of a first signal. The first configuration information is associated with a first communication procedure of the first communication apparatus 110. The third communication apparatus 130 determines (1120) second configuration information of the first signal. The second configuration information is associated with a second communication procedure of the first communication apparatus 110.

The third communication apparatus 130 sends (1130) the first configuration information of the first signal to the second communication apparatus 120. Correspondingly, the second communication apparatus 120 receives (1135) the first configuration information from the third communication apparatus 130.

The third communication apparatus 130 sends (1140) the first configuration information of the first signal to the first communication apparatus 110. Correspondingly, the first communication apparatus 110 receives (1145) the first configuration information from the third communication apparatus 130.

The third communication apparatus 130 sends (1160) the second configuration information of the first signal to the second communication apparatus 120. Correspondingly, the second communication apparatus 120 receives (1165) the second configuration information from the third communication apparatus 130.

The third communication apparatus 130 sends (1170) the second configuration information of the first signal to the first communication apparatus 110. Correspondingly, the first communication apparatus 110 receives (1175) the second configuration information from the third communication apparatus 130.

Then, the first communication apparatus 110 sends the first signal based on at least one of the first configuration information or the second configuration information. Correspondingly, the second communication apparatus 120 receives the first signal based on the at least one of the first configuration information or the second configuration information.

In some implementations, optionally, the first communication apparatus 110 may send (1150) the first signal based on the first configuration information. Correspondingly, the second communication apparatus 120 may receive (1155) the first signal based on the first configuration information.

In some implementations, optionally, the first communication apparatus 110 may send (1180) the first signal based on the second configuration information. Correspondingly, the second communication apparatus 120 may receive (1185) the first signal based on the second configuration information.

It may be understood that although it is shown in FIG. 11 that the action 1140 is performed after the action 1130, this is merely an example. In another example, the action 1130 and the action 1140 may be performed in parallel. Similarly, the action 1160 and the action 1170 may also be performed in parallel. In addition, in another embodiment, the action 1130 and the action 1160 may be combined into one action. In other words, the third communication apparatus 130 simultaneously sends the first configuration information and the second configuration information to the second communication apparatus 120. Similarly, the action 1140 and the action 1170 may also be combined into one action. In other words, the third communication apparatus 130 simultaneously sends the first configuration information and the second configuration information to the first communication apparatus 110.

FIG. 12 is a flowchart of a communication method 1200 according to some embodiments of this disclosure. In some implementations, the method 1200 may be implemented by the third communication apparatus 130 in the example communication system 100, for example, may be implemented by a processor or a processing unit of the third communication apparatus 130 in cooperation with another component (for example, a transceiver). In another embodiment, the method 1200 may also be implemented by another communication apparatus independent of the example communication system 100. For ease of description, the method 1200 is described with reference to FIG. 1.
1210: The third communication apparatus 130 determines first configuration information of a first signal, where the first configuration information is associated with a first communication procedure of the first communication apparatus 110.
1220: The third communication apparatus 130 determines second configuration information of the first signal, where the second configuration information is associated with a second communication procedure of the first communication apparatus 110.
1230: The third communication apparatus 130 sends the first configuration information of the first signal.
1240: The third communication apparatus 130 sends the second configuration information of the first signal.

In this way, a same signal can be used for different communication procedures so that resource utilization can be improved.

In some implementations, a sequence of 1210 and 1220 is not limited. 1210 may be performed before 1220, or 1220 may be performed before 1210, or 1210 and 1220 may be performed simultaneously. In some implementations, a sequence of 1230 and 1240 is not limited. 1230 may be performed before 1240, or 1240 may be performed before 1230, or 1230 and 1240 may be performed simultaneously.

In some implementations, the method 1200 further includes: sending the first configuration information or a plurality of first configuration information sets of the first signal to the first communication apparatus 110. In some implementations, the method 1200 further includes: sending the first configuration information or the plurality of first configuration information sets of the first signal to the second communication apparatus 120. The first configuration information of the first signal is sent in this manner so that signaling overheads can be reduced.

In some implementations, the method 1200 further includes: sending the second configuration information or a plurality of second configuration information sets of the first signal to the first communication apparatus 110. In some implementations, the method 1200 further includes: sending the second configuration information or the plurality of second configuration information sets of the first signal to the second communication apparatus 120. The second configuration information of the first signal is sent in this manner so that signaling overheads can be reduced.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus 110 and the second communication apparatus 120; beam selection for communication between the first communication apparatus 110 and the second communication apparatus 120; or beam recovery for communication between the first communication apparatus 110 and the second communication apparatus 120.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence. The first configuration information and/or the second configuration information of the first signal are/is sent in this manner so that flexible configuration of the foregoing parameters can be implemented. In addition, different parameter values may be configured for different types of communication apparatuses, different communication procedures, and the like, to meet requirements of different users and to improve communication efficiency and performance.

FIG. 13 is a schematic block diagram of a first communication apparatus 1300 according to some embodiments of this disclosure. The first communication apparatus 1300 may be implemented as a device or a chip in a device. The scope of this disclosure is not limited in this aspect. The communication apparatus 1300 may include a plurality of modules for performing corresponding steps in the method 900 discussed in FIG. 9. The communication apparatus 1300 may be implemented as the first communication apparatus 110 shown in FIG. 1 or a part of the first communication apparatus 110.

As shown in FIG. 13, the first communication apparatus 1300 includes a first obtaining unit 1310, a second obtaining unit 1320, and a sending unit 1330. The first obtaining unit 1310 is configured to obtain first configuration information of a first signal, where the first configuration information is associated with a first communication procedure of the first communication apparatus 1300. The second obtaining unit 1320 is configured to obtain second configuration information of the first signal, where the second configuration information is associated with a second communication procedure of the first communication apparatus 1300. The sending unit 1330 is configured to send the first signal based on at least one of the first configuration information or the second configuration information.

In some implementations, the first obtaining unit 1310 and the second obtaining unit 1320 each may be a processing unit.

In some implementations, the first communication apparatus 1300 further includes a receiving unit. The receiving unit is configured to receive the first configuration information from a second communication apparatus. The first obtaining unit 1310 is configured to obtain the first configuration information.

In some implementations, the first communication apparatus 1300 further includes a receiving unit. The receiving unit is configured to receive a plurality of first configuration information sets of the first signal. The first obtaining unit 1310 is further configured to obtain the first configuration information from the plurality of first configuration information sets.

In some implementations, the first obtaining unit 1310 is further configured to obtain the first configuration information based on at least one of the following: a capability of the first communication apparatus 1300, a position of the first communication apparatus 1300, a moving speed of the first communication apparatus 1300, or a type of the first communication apparatus 1300.

In some implementations, the first obtaining unit 1310 is configured to: obtain a plurality of first configuration information sets of the first signal; and obtain the first configuration information from the plurality of first configuration information sets based on the first communication procedure and the type of the first communication apparatus 1300.

In some implementations, the second obtaining unit 1320 is configured to: receive the second configuration information from the second communication apparatus; receive a plurality of second configuration information sets of the first signal, and obtain the second configuration information from the plurality of first configuration information sets; or obtain the second configuration information based on at least one of the following: the capability of the first communication apparatus 1300, the position of the first communication apparatus 1300, the moving speed of the first communication apparatus 1300, or the type of the first communication apparatus 1300.

In some implementations, obtaining the second configuration information based on the type of the first communication apparatus 1300 includes: obtaining a plurality of second configuration information sets of the first signal; and obtaining the second configuration information from the plurality of second configuration information sets based on the second communication procedure and the type of the first communication apparatus 1300.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus 1300 and the second communication apparatus; beam selection for communication between the first communication apparatus 1300 and the second communication apparatus; or beam recovery for communication between the first communication apparatus 1300 and the second communication apparatus.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

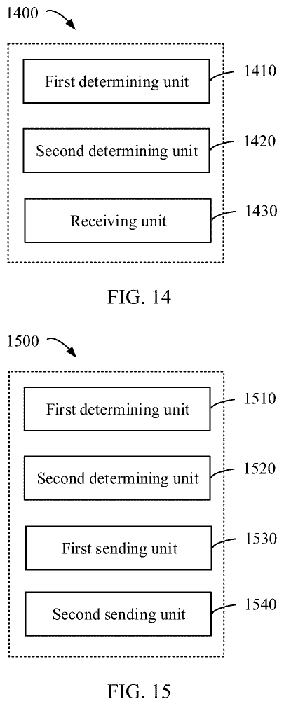

FIG. 14 is a schematic block diagram of a communication apparatus 1400 according to some embodiments of this disclosure. The communication apparatus 1400 may be implemented as a device or a chip in a device. The scope of this disclosure is not limited in this aspect. The communication apparatus 1400 may include a plurality of modules for performing corresponding steps in the method 1000 discussed in FIG. 10. The communication apparatus 1400 may be implemented as the second communication apparatus 120 shown in FIG. 1 or a part of the second communication apparatus 120.

As shown in FIG. 14, the communication apparatus 1400 includes a first determining unit 1410, a second determining unit 1420, and a receiving unit 1430. The first determining unit 1410 is configured to determine first configuration information of a first signal, where the first configuration information is associated with a first communication procedure of a first communication apparatus. The second determining unit 1420 is configured to determine second configuration information of the first signal, where the second configuration information is associated with a second communication procedure of the first communication apparatus. The receiving unit 1430 is configured to receive the first signal based on at least one of the first configuration information or the second configuration information.

In some implementations, the first determining unit 1410 and the second determining unit 1420 each may be a processing unit.

In some implementations, the first configuration information is associated with a first identifier of a synchronization signal block; and/or the second configuration information is associated with a second identifier of the synchronization signal block.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

FIG. 15 is a schematic block diagram of a communication apparatus 1500 according to some embodiments of this disclosure. The communication apparatus 1500 may be implemented as a device or a chip in a device. The scope of this disclosure is not limited in this aspect. The communication apparatus 1500 may include a plurality of modules for performing corresponding steps in the method 1200 discussed in FIG. 12. The communication apparatus 1500 may be implemented as the third communication apparatus 130 shown in FIG. 1 or a part of the third communication apparatus 130.

As shown in FIG. 15, the communication apparatus 1500 includes a first determining unit 1510, a second determining unit 1520, a first sending unit 1530, and a second sending unit 1540. The first determining unit 1510 is configured to determine first configuration information of a first signal, where the first configuration information is associated with a first communication procedure of a first communication apparatus. The second determining unit 1520 is configured to determine second configuration information of the first signal, where the second configuration information is associated with a second communication procedure of the first communication apparatus. The first sending unit 1530 is configured to send the first configuration information of the first signal. The second sending unit 1540 is configured to send the second configuration information of the first signal.

In some implementations, the first determining unit 1510 and the second determining unit 1520 each may be a processing unit.

In some implementations, the first sending unit 1530 is further configured to send the first configuration information or a plurality of first configuration information sets of the first signal to the first communication apparatus 110. The first configuration information of the first signal is sent in this manner so that signaling overheads can be reduced.

In some implementations, the first sending unit 1530 is further configured to send the first configuration information or the plurality of first configuration information sets of the first signal to the second communication apparatus 120.

In some implementations, the plurality of first configuration information sets may be predefined in a protocol. The first configuration information of the first signal is sent in this manner so that signaling overheads can be reduced.

In some implementations, the second sending unit 1540 is further configured to send the second configuration information or a plurality of second configuration information sets of the first signal to the first communication apparatus 110.

In some implementations, the second sending unit 1540 is further configured to send the second configuration information or the plurality of second configuration information sets of the first signal to the second communication apparatus 120.

In some implementations, the plurality of second configuration information sets may be predefined in a protocol. The second configuration information of the first signal is sent in this manner, so that signaling overheads can be reduced.

In some implementations, the first configuration information is associated with a first identifier of a synchronization signal block; and/or the second configuration information is associated with a second identifier of the synchronization signal block.

In some implementations, the first configuration information is associated with a first resource identifier of a channel state information reference signal; and/or the second configuration information is associated with a second resource identifier of the channel state information reference signal.

In some implementations, the first communication procedure is initial access, and the second communication procedure includes at least one of the following: uplink synchronization; channel sounding between the first communication apparatus and the second communication apparatus; beam selection for communication between the first communication apparatus and the second communication apparatus; or beam recovery for communication between the first communication apparatus and the second communication apparatus.

In some implementations, the first signal includes one of the following: a sounding reference signal; or a preamble sequence.

In some implementations, the first configuration information and/or the second configuration information indicate/indicates at least one of the following parameters: a subcarrier spacing of the first signal; a cyclic prefix length of the first signal; a time-domain length of the first signal; a quantity of combs of the first signal; a time-domain resource of the first signal; a frequency-domain resource of the first signal; a signal sequence of the first signal; or information associated with generation of the signal sequence.

The foregoing details that are of the second communication apparatus 120 sending the first configuration information and the second configuration information and that are described with reference to FIG. 2 to FIG. 10 are also applicable to the embodiment in which the third communication apparatus 130 sends the configuration information. Therefore, details are not described herein again.

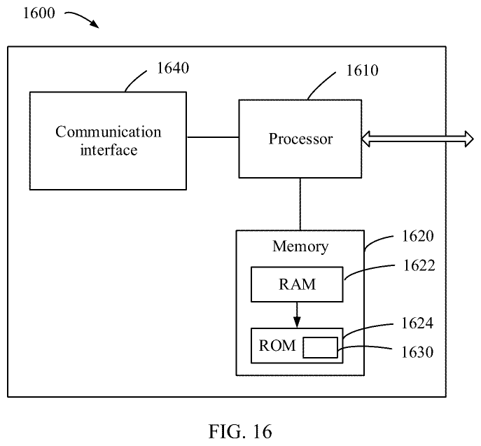

FIG. 16 is a simplified block diagram of an example device 1600 suitable for implementing embodiments of this disclosure. The device 1600 may be configured to implement the first communication apparatus 110, the second communication apparatus 120, or the third communication apparatus 130 shown in FIG. 1. As shown in the figure, the device 1600 includes one or more processors (or processing units) 1610, and may further include one or more memories 1620 coupled to the processors 1610, and a communication interface 1640 coupled to the processor 1610.

The communication interface 1640 may be for communication with another device or apparatus, for example, sending or receiving of data and/or a signal. The communication interface 1640 may include at least one communication interface used for communication. The communication interface may include any interface necessary for communication with another device. For example, the communication interface may be a transceiver, a circuit, a bus, a module, or another type of communication interface.

The processor 1610 may include but is not limited to at least one of the following: a general-purpose computer, a dedicated computer, a microcontroller, a digital signal controller (DSP), or a controller-based multi-core controller architecture. The device 1600 may have a plurality of processors, such as an application-specific integrated circuit chip, which belongs, in terms of time, to a clock synchronized with a main processor.

The memory 1620 may include one or more nonvolatile memories and one or more volatile memories. Examples of the nonvolatile memory include but are not limited to at least one of the following: a read-only memory (ROM) 1624, an erasable programmable read-only memory (EPROM), a flash memory, a hard disk, a compact disc (CD), a digital video disc (DVD), or other magnetic storage and/or optical storage. Examples of the volatile memory include but are not limited to at least one of the following: a random access memory (RAM) 1622, or another volatile memory that does not last for power-off duration.

A computer program 1630 includes computer-executable instructions executed by the associated processor 1610. The program 1630 may be stored in the ROM 1620. The processor 1610 may perform any proper action and processing by loading the program 1630 into the ROM 1620.

Embodiments of this disclosure may be implemented by using the program 1630 so that the device 1600 may perform any process discussed with reference to FIG. 2 to FIG. 15. Embodiments of this disclosure may alternatively be implemented by hardware or a combination of software and hardware.

In some implementations, the program 1630 may be tangibly included in a computer-readable medium, and the computer-readable medium may be included in the device 1600 (for example, in the memory 1620) or another storage device that can be accessed by the device 1600. The program 1630 may be loaded from the computer-readable medium to the RAM 1622 for execution. The computer-readable medium may include any type of tangible nonvolatile memory, for example, a ROM, an EPROM, a flash memory, a hard disk, a CD, or a DVD.

In some implementations, this disclosure further provides a communication system, including a first communication apparatus 1300 and a second communication apparatus 1400.

In some implementations, the communication system may further include a third communication apparatus 1500.

Generally, various embodiments of this disclosure may be implemented by hardware or a dedicated circuit, software, logic, or any combination thereof. Some aspects may be implemented by hardware, and other aspects may be implemented by firmware or software, and may be performed by a controller, a microprocessor, or another computing device. Although various aspects of embodiments of this disclosure are shown and described as block diagrams or flowcharts, or represented by using some other figures, it should be understood that the blocks, apparatuses, systems, technologies, or methods described in this specification may be implemented as, for example, but not limited to, hardware, software, firmware, dedicated circuits, logic, general-purpose hardware, controllers, other computing devices, or a combination thereof.

This disclosure further provides at least one computer program product tangibly stored in a non-transitory computer-readable storage medium. The computer program product includes computer-executable instructions, such as instructions included in a program module, which are executed in a device on a target real or virtual processor to perform the foregoing processes/methods described with reference to FIG. 2 to FIG. 15. Usually, a program module includes a routine, a program, a library, an object, a class, a component, a data structure, or the like that executes a specific task or implements a specific abstract data type. In various embodiments, functions of program modules may be combined or split between the program modules as required. Machine-executable instructions for the program module may be executed locally or in a distributed device. In the distributed device, the program module may be locally located and located in a remote storage medium.

Program code for implementing the methods of this disclosure may be written in any combination of one or more programming languages. The program code may be provided to a processor or a controller of a general-purpose computer, a dedicated computer, or another programmable data processing apparatus so that when the program code is executed by the processor or controller, the functions/operations specified in the flowcharts and/or the block diagrams are implemented. The program code may be completely executed on a machine, partially executed on a machine, partially executed on a machine as a stand-alone software package and partially executed on a remote machine, or completely executed on a remote machine or server.

In the context of this disclosure, the machine-readable medium may be a tangible medium, and may include or store a program for use by or in combination with an instruction execution system, an apparatus, or a device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any appropriate combination of the foregoing content. A more specific example of the machine-readable storage medium includes an electrical connection based on one or more lines, a portable computer disk, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any appropriate combination of the foregoing content.

In addition, although operations are described in a particular order, it should be understood as that it is required that the operations are performed in the shown particular order or in sequence, or it is required that all operations shown in the figures should be performed to achieve an expected result. In a specific environment, multi-task and parallel processing may be advantageous. Similarly, although several specific implementation details are included in the foregoing descriptions, these should not be construed as a limitation on the scope of this disclosure. Some features described in the context of an individual embodiment may alternatively be implemented in combination in a single implementation. On the contrary, various features described in the context of a single implementation may alternatively be implemented in a plurality of implementations individually or in any appropriate sub-combination.

Although the subject matter is described in a language specific to structural features and/or method logic actions, it should be understood that the subject matter defined in the appended claims is not necessarily limited to the particular features or actions described above. On the contrary, the particular features and actions described above are merely example forms for implementing the claims.

What is claimed is:

1. A method, wherein the method is applicable to a first apparatus and the method comprises:
obtaining first configuration information of a first signal, where the first configuration information is associated with a first procedure of the first apparatus;
obtaining second configuration information of the first signal, where the second configuration information is associated with a second procedure of the first apparatus; and
sending the first signal based on at least one of the first configuration information and the second configuration information.

2. The method according to claim 1, where the first configuration information is obtained from at least one of the following:
a second apparatus; or
a plurality of first configuration information sets of the first signal, the plurality of first configuration information sets including the first configuration information.

3. The method according to claim 1, where the first configuration information is associated with at least one of:
a plurality of first configuration information sets of the first signal, the plurality of first configuration information sets including the first configuration information;
a capability of the first apparatus;
a position of the first apparatus;
a moving speed of the first apparatus;
a type of the first apparatus;
a first identifier of a synchronization signal block; or
a first resource identifier of a channel state information reference signal.

4. The method according to claim 3, where the plurality of first configuration information sets of the first signal are obtained from the second apparatus or a third apparatus; or
the plurality of first configuration information sets of the first signal are predefined.

5. The method according to claim 1, where the first configuration information is associated with a first procedure and a type of the first apparatus.

6. The method according to claim 1, where the second configuration information is obtained from at least one of the following:
the second apparatus; or
a plurality of second configuration information sets of the first signal, the plurality of second configuration information sets including the second configuration information.

7. The method according to claim 6, where the plurality of second configuration information sets of the first signal is obtained from the second apparatus or the third apparatus; or
the plurality of second configuration information sets of the first signal are predefined.

8. The method according to claim 1, where the second configuration information is associated with a second procedure and a type of the first apparatus.

9. A method, wherein the method is applicable to a second communication apparatus and the method comprises:
determining first configuration information of a first signal, where the first configuration information is associated with a first procedure of a first apparatus;
determining second configuration information of the first signal, where the second configuration information is associated with a second procedure of the first apparatus; and
receiving the first signal from the first apparatus based on at least one of the first configuration information and the second configuration information.

10. The method according to claim 9, further comprising sending at least one of the following to the first apparatus:
the first configuration information, or
a plurality of first configuration information sets of the first signal.

11. The method according to claim 1, where the first configuration information is associated with at least one of:
a plurality of first configuration information sets of the first signal, the plurality of first configuration information sets including the first configuration information;
a capability of the first apparatus,
a position of the first apparatus,
a moving speed of the first apparatus,
a type of the first apparatus;
a first identifier of a synchronization signal block; or.
a first resource identifier of a channel state information reference signal.

12. The method according to claim 1, where the first procedure is initial access, and the second procedure comprises at least one of the following:
uplink synchronization;
channel sounding between the first apparatus and the second apparatus;
beam selection for communication between the first apparatus and the second apparatus; or
beam recovery for communication between the first apparatus and the second apparatus.

13. The method according to claim 1, where the first signal comprises one of the following:
a sounding reference signal; or
a preamble sequence.

14. The method according to claim 1, where the first configuration information indicates at least one of the following parameters:
a subcarrier spacing of the first signal;
a cyclic prefix length of the first signal;
a time-domain length of the first signal;
a quantity of combs of the first signal;
a time-domain resource of the first signal;
a frequency-domain resource of the first signal;
a signal sequence of the first signal; or
information associated with generation of the signal sequence.

15. A first apparatus, comprising:
at least one processing circuit, and
an interface coupled with the at least one processing circuit, wherein the at least one processing circuit is configured to:
obtain first configuration information of a first signal, where the first configuration information is associated with a first procedure of the first apparatus; and
obtain second configuration information of the first signal, where the second configuration information is associated with a second procedure of the first apparatus; and
wherein the interface is configured to send the first signal based on at least one of the first configuration information or the second configuration information.

16. The first apparatus according to claim 15, where the first configuration information is obtained from at least one of the following:
a second apparatus; or
a plurality of first configuration information sets of the first signal, the plurality of first configuration information sets including the first configuration information.

17. The first apparatus according to claim 15, where the first configuration information is associated with at least one of:
a plurality of first configuration information sets of the first signal, the plurality of first configuration information sets including the first configuration information;
a capability of the first apparatus,
a position of the first apparatus,
a moving speed of the first apparatus,
a type of the first apparatus;
a first identifier of a synchronization signal block; or
a first resource identifier of a channel state information reference signal.

18. The first apparatus according to claim 15, where the first procedure is initial access, and the second procedure comprises at least one of the following:
uplink synchronization;
channel sounding between the first apparatus and the second apparatus;
beam selection for communication between the first apparatus and the second apparatus; or
beam recovery for communication between the first apparatus and the second apparatus.

19. The first apparatus according to claim 15, where the first signal comprises one of the following:
a sounding reference signal; or
a preamble sequence.

20. The first apparatus according to claim 15, where the first configuration information indicates at least one of the following parameters:
a subcarrier spacing of the first signal;
a cyclic prefix length of the first signal;
a time-domain length of the first signal;
a quantity of combs of the first signal;
a time-domain resource of the first signal;
a frequency-domain resource of the first signal;
a signal sequence of the first signal; or
information associated with generation of the signal sequence.
